(19) United States
(12) Patent Application Publication
(10) Pub. No.: US 2025/0300797 A1
(43) Pub. Date: Sep. 25, 2025

(54) METHOD AND APPARATUS FOR TRANSMITTING UPLINK CHANNEL AND SIGNAL IN WIRELESS COMMUNICATION SYSTEM

(71) Applicant: Samsung Electronics Co., Ltd., Suwon-si (KR)

(72) Inventors: Kyungjun CHOI, Suwon-si (KR); Seongmok LIM, Suwon-si (KR); Youngrok JANG, Suwon-si (KR); Hyoungju JI, Suwon-si (KR)

(21) Appl. No.: 19/085,422

(22) Filed: Mar. 20, 2025

(30) Foreign Application Priority Data
Mar. 22, 2024 (KR) 10-2024-0040004

(51) Int. Cl. H04L 5/14; H04L 5/00; H04W 72/21; H04W 74/0833

(52) U.S. Cl. CPC H04L 5/14; H04L 5/0098; H04W 72/21; H04W 74/0833

(57) ABSTRACT

The disclosure relates to a fifth generation (5G) or sixth generation (6G) communication system for supporting higher data rates. A method performed by a terminal in a wireless communication system is provided. The method includes receiving, from a base station, configuration information associated with a subband non-overlapping full duplex (SBFD) symbol, identifying whether one or more symbols allocated for a physical uplink shared channel (PUSCH) associated with random access are all SBFD symbols and do not include a symbol of a synchronization signal (SS)/physical broadcast channel (PBCH) block, and, in case that the one or more symbols allocated for the PUSCH are all SBFD symbols and do not include the symbol of the SS/PBCH block, transmitting, to the base station, the PUSCH, wherein the SBFD symbol is for an uplink transmission using at least one of a downlink symbol or a flexible symbol.

### CROSS REFERENCE TO RELATED APPLICATION(S)

This application is based on and claims priority under 35 U.S.C. § 119(a) of a Korean Patent Application number 10-2024-0040004, filed on Mar. 22, 2024, in the Korean Intellectual Property Office, the disclosure of which is incorporated by reference herein in its entirety.

### BACKGROUND

### 1. Field

The disclosure relates to operations of a terminal and a base station in a wireless communication system. More particularly, the disclosure relates to an apparatus capable of performing Msg3 physical uplink shared channel (PUSCH) transmission by a terminal.

### 2. Description of the Related Art

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter (mm) Wave including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple input multiple output (MIMO) for mitigating radio-wave path loss and increasing radio-wave transmission distances in millimeter wave (mmWave), supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service-based architecture or service-based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and method capable of effectively providing a service in a mobile communication system.

Additional aspects will be set forth in part in the description which follows and, in part, will be apparent from the description, or may be learned by practice of the presented embodiments.

In accordance with an aspect of the disclosure, a method performed by a terminal in a wireless communication system is provided. The method includes receiving, from a base station, configuration information associated with a subband non-overlapping full duplex (SBFD) symbol, identifying whether one or more symbols allocated for a physical uplink shared channel (PUSCH) associated with random access are all SBFD symbols and do not include a symbol of a synchronization signal (SS)/physical broadcast channel (PBCH) block, and, in case that the one or more symbols allocated for the PUSCH are all SBFD symbols and do not include the symbol of the SS/PBCH block, transmitting, to the base station, the PUSCH, wherein the SBFD symbol is for an uplink transmission using at least one of a downlink symbol or a flexible symbol.

In accordance with an aspect of the disclosure, a method performed by a base station in a wireless communication system is provided. The method includes transmitting, to a terminal, configuration information associated with a subband non-overlapping full duplex (SBFD) symbol, and, in case that one or more symbols allocated for a physical uplink shared channel (PUSCH) associated with random access (RA) are all SBFD symbols and do not include a symbol of a synchronization signal (SS)/physical broadcast channel (PBCH) block, receiving, from the terminal, the PUSCH, wherein the SBFD symbol is for an uplink transmission using at least one of a downlink symbol or a flexible symbol.

In accordance with another aspect of the disclosure, a terminal for transmitting an uplink channel and a signal in a wireless communication system is provided. The terminal includes a transceiver configured to receive and transmit a signal, memory, comprising one or more storage media, storing instructions, and one or more processors communicatively coupled to the transceiver and the memory, wherein the instructions, when executed by the one or more processors individually or collectively, cause the terminal to receive, from a base station, configuration information associated with a subband non-overlapping full duplex (SBFD) symbol, identify whether one or more symbols allocated for a physical uplink shared channel (PUSCH) associated with random access are all SBFD symbols and do not include a symbol of a synchronization signal (SS)/physical broadcast channel (PBCH) block, and in case that the one or more symbols allocated for the PUSCH are all SBFD symbols and do not include the symbol of the SS/PBCH block, transmit, to the base station, the PUSCH, wherein the SBFD symbol is for an uplink transmission using at least one of a downlink symbol or a flexible symbol.

In accordance with an aspect of the disclosure, a base station in a wireless communication system is provided. The base station includes a transceiver, and at least one processor coupled with the transceiver and configured to transmit, to a terminal, configuration information associated with a subband non-overlapping full duplex (SBFD) symbol, and, in case that one or more symbols allocated for a physical uplink shared channel (PUSCH) associated with random access (RA) are all SBFD symbols and do not include a symbol of a synchronization signal (SS)/physical broadcast channel (PBCH) block, receive, from the terminal, the PUSCH, wherein the SBFD symbol is for an uplink transmission using at least one of a downlink symbol or a flexible symbol.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a basic structure of a time-frequency domain in a wireless communication system according to an embodiment of the disclosure;

FIG. 2 is a diagram illustrating frame, subframe, and slot structures in the wireless communication system according to an embodiment of the disclosure;

FIG. 3 is a diagram illustrating an example of a bandwidth part configuration in the wireless communication system according to an embodiment of the disclosure;

FIG. 4 is a diagram illustrating an example of a control resource set configuration of a downlink control channel in the wireless communication system according to an embodiment of the disclosure;

FIG. 5 is a diagram illustrating a structure of the downlink control channel in the wireless communication system according to an embodiment of the disclosure;

FIG. 6 is a diagram illustrating a method for a base station and a terminal (UE) to transmit and receive data in consideration of a downlink data channel and rate matching resources in the wireless communication system according to an embodiment of the disclosure;

FIG. 7 is a diagram illustrating an example of frequency-domain resource allocation of a physical downlink shared channel (PDSCH) in the wireless communication system according to an embodiment of the disclosure;

FIG. 8 is a diagram illustrating an example of time-domain resource allocation of a PDSCH in the wireless communication system according to an embodiment of the disclosure;

FIG. 9 is a diagram illustrating an example of the time-domain resource allocation according to a subcarrier spacing of a data channel and a control channel in the wireless communication system according to an embodiment of the disclosure;

FIG. 10 is a diagram illustrating a wireless protocol structure of the base station and the UE in a single cell, carrier aggregation, and a dual connectivity situation in the wireless communication system according to an embodiment of the disclosure;

FIG. 11 is a diagram illustrating a random access procedure in according to an embodiment of the disclosure;

FIG. 12 is a diagram illustrating a time division duplex (TDD) configuration and a subband non-overlapping full duplex (SBFD) configuration according to an embodiment of the disclosure;

FIGS. 13A and 13B are diagrams illustrating PUSCH transmittable symbols in the TDD configuration and the SBFD configuration according to various embodiments of the disclosure;

FIG. 14 is a diagram illustrating a flowchart for an Msg3 PUSCH transmission according to an embodiment of the disclosure;

FIG. 15 is a diagram illustrating a flowchart for determining an Msg PUSCH frequency hopping offset value according to an embodiment of the disclosure;

FIG. 16 is a diagram illustrating a structure of the UE in the wireless communication system according to an embodiment of the disclosure; and

FIG. 17 is a diagram illustrating a structure of the base station in the wireless communication system according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Various advantages and features of the disclosure and methods accomplishing the same will become apparent from the following detailed description of embodiments with reference to the accompanying drawings. However, the disclosure is not limited to various embodiments to be described below, but may be implemented in various different forms, the embodiments will be provided only in order to make the disclosure complete and allow those skilled in the art to completely recognize the scope of the disclosure, and the disclosure will be defined by the scope of the claims. Throughout the specification, the same components will be denoted by the same reference numerals. In addition, in describing the disclosure, when it is determined that a detailed description for the related functions or configurations related to the disclosure may unnecessarily obscure the gist of the disclosure, the detailed description therefor will be omitted. Further, the following terminologies are defined in consideration of the functions in the disclosure and may be construed in different ways by the intention of users and operators, practice, etc. Therefore, the definitions thereof should be construed based on the contents throughout the specification.

Hereinafter, a base station is an entity that performs resource allocation of a terminal, and may be at least one of a gNode B, an eNode B, a Node B, a base station (BS), a wireless access unit, a base station controller, or a node on a network. The terminal may include user equipment (UE), a mobile station (MS), a cellular phone, a smartphone, a computer, or a multimedia system capable of performing a communication function. In the disclosure, downlink (DL) refers to a wireless transmission path of a signal that the base station transmits to the UE, and uplink (UL) refers to a wireless transmission path of a signal that the UE transmits to the base station. In addition, although an LTE or LTE-A system may be described below as an example, embodiments of the disclosure may be applied to other communication systems having similar technical backgrounds or channel types. For example, 5G generation mobile communication technologies (new radio (NR)) developed after the LTE-A may be included in the system, and the 5G below may be a concept that includes the existing LTE, LTE-A, and other similar services. In addition, the disclosure may be applied to other communication systems through some modifications without significantly departing from the scope of the disclosure as determined by a person having skilled technical knowledge.

In this case, it will be appreciated that each block of a processing flowchart and combinations of the flowcharts may be executed by computer program instructions. Since these computer program instructions may be mounted in a processor of a general computer, a special computer, or other programmable data processing apparatuses, these computer program instructions executed through the processor of the computer or the other programmable data processing apparatuses create means performing functions described in a block (s) of the flow chart. Since these computer program instructions may also be stored in a computer usable or computer readable memory of a computer or other programmable data processing apparatuses in order to implement the functions in a specific scheme, the computer program instructions stored in the computer usable or computer readable memory can also produce manufacturing articles including instruction means performing the functions described in the block(s) of the flowchart. Since the computer program instructions may also be mounted on the computer or the other programmable data processing apparatuses, the instructions performing a series of operation steps on the computer or the other programmable data processing apparatuses to create processes executed by the computer, thereby executing the computer or the other programmable data processing apparatuses may also provide steps for performing the functions described in a block(s) of the flowchart.

In addition, each block may indicate some of modules, segments, or codes including one or more executable instructions for executing a specific logical function(s). Further, it is to be noted that functions mentioned in the blocks occur regardless of an order in some alternative embodiments. For example, two blocks that are continuously illustrated may be simultaneously performed in fact or be performed in a reverse order depending on corresponding functions.

In this case, the term ‘unit’ used in the embodiment refers to software or a hardware component such as a field programmable gate array (FPGA) or an application specific integrated circuit (ASIC), and ‘unit’ play certain roles. However, ‘unit’ is not limited to the software or the hardware. The ‘unit’ may be configured to be stored in a storage medium that can be addressed or may be configured to reproduce one or more processors. Accordingly, as an example, the ‘unit’ includes components such as software components, object-oriented software components, class components, and task components, processes, functions, attributes, procedures, subroutines, segments of program code, drivers, firmware, microcode, circuits, data, databases, data structures, tables, arrays and variables. Components and functions provided within ‘unit’ may be combined into a smaller number of components and ‘unit’ or may be further separated into additional components and ‘unit.’ In addition, components and ‘units’ may be implemented to reproduce one or more central processing units (CPUs) in a device or a security multimedia card. In addition, in embodiments, the ‘unit’ may include one or more processors.

Wireless communication systems have evolved from providing voice-oriented services in their early stages to becoming broadband wireless communication systems that provide high-speed, high-quality packet data services, as exemplified by communication standards such as 3GPP's high speed packet access (HSPA), long term evolution (LTE) or evolved universal terrestrial radio access (E-UTRA), LTE-Advanced (LTE-A), and LTE-Pro, 3GPP2's high rate packet data (HRPD) and ultra mobile broadband (UMB), and IEEE's 802.16e.

As a representative example of the broadband wireless communication systems, the LTE system has adopted an orthogonal frequency division multiplexing (OFDM) scheme in downlink (DL) and a single carrier frequency division multiple access (SC-FDMA) scheme in uplink (UL). The uplink refers to a wireless link in which a terminal (user equipment (UE) or mobile station (MS)) transmits data or control signals to a base station (eNode B or base station (BS)), and downlink refers to a wireless link in which a base station transmits data or control signals to a UE. The multiple access scheme as described above may usually allocate and operate time-frequency resources for carrying and transmitting data or control information to each user so that the time-frequency resources do not overlap with each other, that is, so that orthogonality is achieved, thereby distinguishing the data or control information for each user.

As future communication systems beyond LTE, that is, a 5G communication system should support services that simultaneously satisfy various requirements since the 5G communication system needs to flexibly reflect various requirements from users, service providers, etc. Examples of services considered for the 5G communication system includes enhanced mobile broadband (eMBB), massive machine type communication (mMTC), ultra reliability low latency communication (URLLC), etc.

The eMBB aims to provide a data rate higher than that supported by the existing LTE, LTE-A, or LTE-Pro. For example, in the 5G communication system, the eMBB should be able to provide a peak data rate of 20 Gbps in the downlink and a peak data rate of 10 Gbps in the uplink from the perspective of a single base station. In addition, the 5G communication system should provide an increased user perceived data rate of a UE while providing the peak data rate. To satisfy these requirements, various transmission and reception technologies, including further improved multiple input multiple output (MIMO) transmission technology, are required. In addition, while the LTE transmits signals using a maximum transmission bandwidth of 20 megahertz (MHz) in the 2 GHz band, the 5G communication system may satisfy a data transmission rate required by the 5G communication system by using a wider frequency bandwidth than 20 MHz in the 3 to 6 GHz or 6 GHz or higher frequency band.

At the same time, the mMTC is being considered to support application services such as the Internet of Things (IoT) in the 5G communication system. In order to efficiently provide the Internet of Things, the mMTC requires large-scale UE access support within a cell, UE coverage improvement, improved battery life time, UE cost reduction, etc. Since the Internet of Things is attached to various sensors and various devices to provide communication functions, the Internet of Things should be able to support a large number of UEs (e.g., 1,000,000 UEs/km2) within a cell. In addition, the UEs supporting the mMTC are likely to be located in shadow areas that cells do not cover, such as basements of buildings, due to the nature of services, so the UEs may require wider coverage than other services provided by the 5G communication system. Since the UEs supporting the mMTC should be composed of low-cost UEs and it is difficult to frequently replace batteries of UEs, a very long battery life time, such as 10 to 15 years, may be required.

Finally, the URLLC is a cellular-based wireless communication service used for mission-critical. For example, services, such as remote control of a robot or machinery, industrial automation, an unmanned aerial vehicle, remote health care, emergency alert, etc., may be considered. Therefore, the communication provided by the URLLC should provide very low latency and very high reliability. For example, a service supporting the URLLC should satisfy an air interface latency of less than 0.5 milliseconds, and at the same time have a requirement of a packet error rate of 10⁻⁵ or less. Therefore, for the service supporting the URLLC, the 5G communication system should provide a smaller transmit time interval (TTI) than other services, and at the same time, a design requirement may be required to allocate wide resources in a frequency band to secure the reliability of a communication link.

Three services of the 5G, such as the eMBB, the URLLC, and the mMTC, may be multiplexed and transmitted in one system. In this case, different transmission and reception techniques and transmission and reception parameters may be used between services to satisfy different requirements of each service. Of course, the 5G is not limited to the three services described above.

### [NR Time-Frequency Resource]

Hereinafter, a frame structure of the 5G communication system is described in more detail with reference to the drawings.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

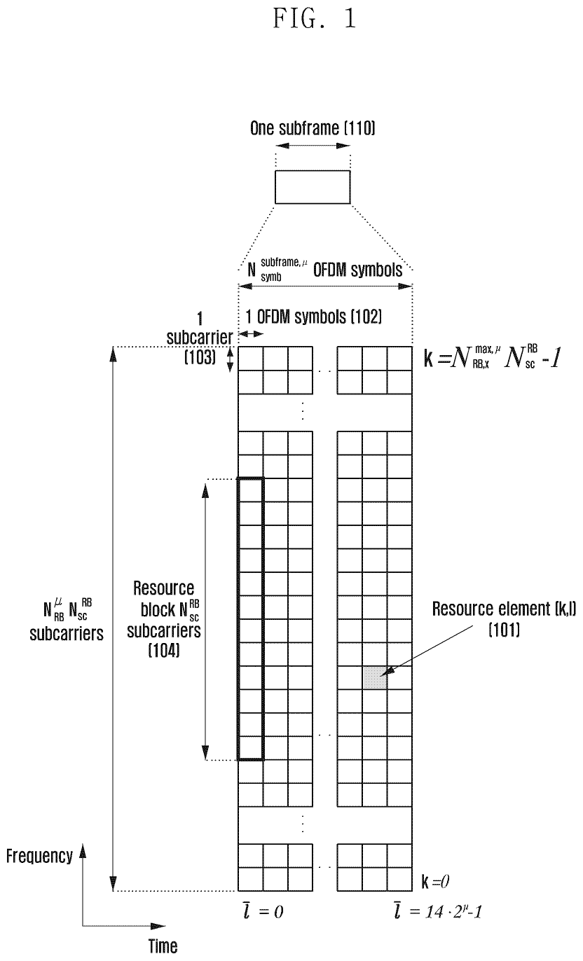

FIG. 1 is a diagram illustrating a basic structure of a time-frequency domain that is a wireless resource domain where data or a control channel is transmitted in the 5G communication system according to an embodiment of the disclosure.

Referring to FIG. 1, a horizontal axis represents a time domain, and a vertical axis represents a frequency domain. A basic unit of resources in the time and frequency domains is a resource element (RE) 101, and may be defined as 1 orthogonal frequency division multiplexing (1 OFDM) symbol 102 on a time-domain and 1 subcarrier 103 on a frequency-domain. In the frequency domain, N_{sc}^{RB} (e.g., 12) consecutive REs may constitute one resource block (RB) 104. The above may be for one subframe 110.

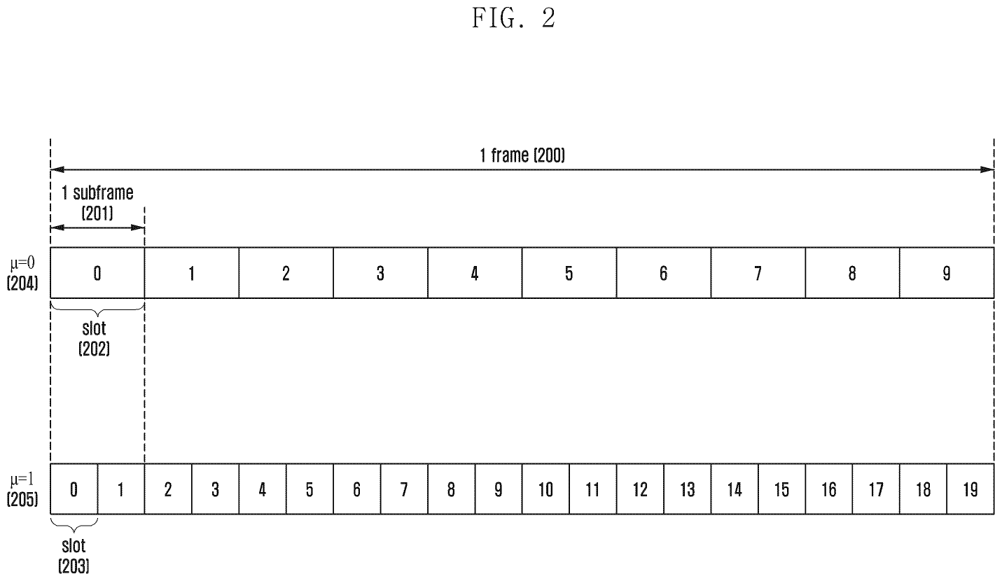

FIG. 2 is a diagram illustrating frame, subframe, and slot structures in the wireless communication system according to an embodiment of the disclosure.

FIG. 2 illustrates an example of frame 200, subframe 201, and slot 202 structures. The 1 frame 200 may be defined as 10 ms. The 1 subframe 201 may be defined as 1 ms, so the 1 frame 200 may be composed of a total of 10 subframes 201. 1 slot 202 and 203 may be defined as 14 OFDM symbols (i.e., the number N_{symb}^{slot} of symbols per slot=14). The 1 subframe 201 may be composed of one or more slots 202 and 203, and the number of slots 202 and 203 per 1 subframe 201 may vary depending on setting values μ 204 and 205 of a subcarrier spacing. Referring to FIG. 2, the cases where μ=0 204 and μ=1 205 are illustrated as the setting value of the subcarrier spacing. When μ=0 204, the 1 subframe 201 may be composed of 1 slot 202, and when μ=1 205, 1 subframe 201 may be composed of 2 slots 203. That is, the number Nₛₗₒₜ^{subframe,μ} of slots per subframe may vary depending on the setting value μ of the subcarrier spacing, and thus, the number Nₛₗₒₜ^{frame, μ} of slots per frame may vary. The Nₛₗₒₜ^{subframe, μ} and Nₛₗₒₜ^{frame, μ} depending on the setting values μ of each subcarrier spacing may be defined as Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Next, a bandwidth part (BWP) configuration in the 5G communication system will be described in detail with reference to the drawings.

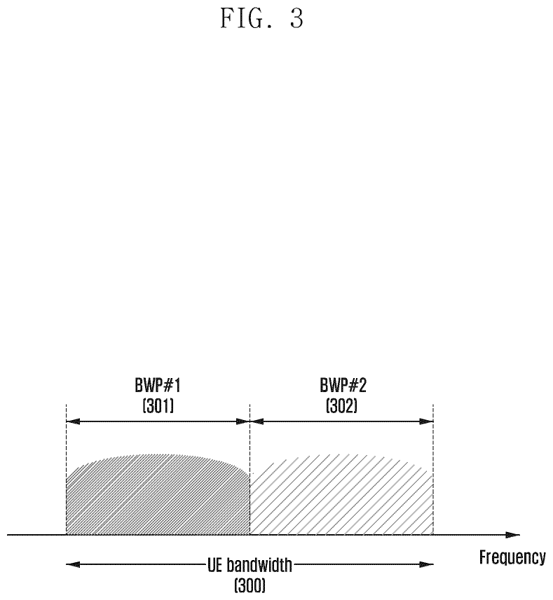

FIG. 3 is a diagram illustrating an example of the bandwidth part configuration in the wireless communication system according to an embodiment of the disclosure.

FIG. 3 illustrates an example in which a UE bandwidth 300 is configured as two bandwidth parts, that is, bandwidth part #1 (BWP #1) 301 and bandwidth part #2 (BWP #2) 302. The base station may configure one or more bandwidth parts for the UE, and may configure information as shown Table 2 below for each bandwidth part.

TABLE 2

| | |
|---|---|
| BWP ::= | SEQUENCE { |
| bwp-Id | BWP-Id, |

(bandwidth part identifier)

| | |
|---|---|
| locationAndBandwidth | INTEGER (1..65536), |

(bandwidth part location)

| | |
|---|---|
| subcarrierSpacing | ENUMERATED {n0, n1, n2, n3, n4, n5}, |

(subcarrier spacing)

| | |
|---|---|
| cyclicPrefix | ENUMERATED { extended } |

(cyclic prefix)
}

Of course, the disclosure is not limited to the above example, and in addition to the configuration information, various parameters related to the bandwidth part may be configured for the UE. The pieces of information may be transmitted from the base station to the UE by higher layer signaling, for example, radio resource control (RRC) signaling. At least one of the one or more configured bandwidth parts may be activated. Whether the configured bandwidth part is activated may be semi-statically transmitted from the base station to the UE through the RRC signaling or dynamically transmitted through downlink control information (DCI).

According to some embodiments, the UE before the radio resource control (RRC) connection may be configured with an initial bandwidth part (initial BWP) for initial access by the base station through a master information block (MIB). More specifically, the UE may receive, through the MIB during the initial access stage, configuration information of a control resource set (CORESET) and a search space where a physical downlink control channel (PDCCH) for receiving system information (which may correspond to remaining system information (RMSI) or system information block 1 (SIB1)) required for initial access may be transmitted. The control resource set and the search space configured by the MIB may each be considered as identity (ID) 0. The base station may notify the UE of configuration information such as frequency allocation information, time allocation information, and numerology for control resource set #0 through the MIB. In addition, the base station may notify the UE of configuration information on monitoring periodicity and occasion for the control resource set #0, i.e., configuration information of search space #0, through the MIB. The UE may consider a frequency domain configured as the control resource set #0, which is acquired from the MIB, as an initial bandwidth part for initial access. In this case, an identifier (ID) of the initial bandwidth part may be considered as 0.

The configuration of the bandwidth part supported by the 5G may be used for various purposes.

According to some embodiments, the case where the bandwidth supported by the UE is smaller than the system bandwidth may be supported through the configuration of the bandwidth part. For example, the base station may configure a frequency position (configuration information 2) of the bandwidth part for the UE, so the UE may transmit and receive data at a specific frequency position within the system bandwidth.

In addition, according to some embodiments, the base station may configure a plurality of bandwidth parts for the UE to support different numerologies. For example, in order to support data transmission and reception using both 15 kilohertz (kHz) subcarrier spacing and 30 kHz subcarrier spacing for a certain UE, two bandwidth parts may be configured to 15 kHz and 30 kHz subcarrier spacing, respectively. Different bandwidth parts may be frequency division multiplexed, and when data is to be transmitted and received using specific subcarrier spacing, the bandwidth part configured to the corresponding subcarrier spacing may be activated.

In addition, according to some embodiments, to reduce the power consumption of the UE, the base station may configure bandwidth parts with different bandwidth sizes for the UE. For example, when the UE supports a very large bandwidth, for example, a bandwidth of 100 MHz, and always transmits and receives data using the corresponding bandwidth, very large power consumption may occur. In particular, monitoring an unnecessary downlink control channel using a large bandwidth of 100 MHz in a situation where there is no traffic may be very inefficient in terms of power consumption. To reduce the power consumption of the UE, the base station may configure a bandwidth part with a relatively small bandwidth, for example, a bandwidth part of 20 MHz, for the UE. In the situation where there is no traffic, the UE may perform a monitoring operation in the bandwidth part of 20 MHz, and when data is generated, the UE may transmit and receive data in the bandwidth part of 100 MHz according to the indication of the base station.

In the method for configuring a bandwidth part, UEs before RRC connected may receive the configuration information of the initial bandwidth part through the master information block (MIB) in the initial access stage. Describing in more detail, the UE may be configured with a control resource set (CORESET) for a downlink control channel on which the downlink control information (DCI) for scheduling a system information block (SIB) may be transmitted from an MIB of a physical broadcast channel (PBCH). A bandwidth of the control resource set configured by the MIB may be considered as the initial bandwidth part, and the UE may receive a physical downlink shared channel (PDSCH) on which the SIB is transmitted through the configured initial bandwidth part. In addition to the purpose of receiving the SIB, the initial bandwidth part may also be utilized for the purpose of other system information (OSI), paging, and random access.

### [Bandwidth Part (BWP) Change]

When one or more bandwidth parts are configured for the UE, the base station may indicate for the UE to change (or switch, transition) the bandwidth part using a bandwidth part indicator field in the DCI. Referring to FIG. 3, when a currently activated bandwidth part of the UE is bandwidth part #1 301, the base station may indicate bandwidth part #2 302 to the UE using the bandwidth part indicator in the DCI, and the UE may perform the bandwidth part change to bandwidth part #2 302 indicated by the bandwidth part indicator within the received DCI.

As described above, since the DCI-based bandwidth part change may be indicated by the DCI that schedules the PDSCH or the PUSCH, when the UE receives the bandwidth part change request, the UE should be able to easily receive or transmit the PDSCH or the PUSCH scheduled by the corresponding DCI in the changed bandwidth part. To this end, requirements for a delay time T_{BWP} required when changing the bandwidth part are specified in the standard, which may be defined as in Table 3, for example.

TABLE 3

| | |
|---|---|
| NR Slot | BWP switch delay T_{BWP} (slots) |

| μ | length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}
Depends on UE capability.
^{Note 2}
If the BWP switch involves changing of SCS, the BWP switch delay is determined by the larger one between the SCS before BWP switch and the SCS after BWP switch.

The requirements for the bandwidth part change delay time supports type 1 or type 2 depending on the UE capability. The UE may report a supportable bandwidth part delay time type to the base station.

According to the requirement for the bandwidth part change delay time described above, when the UE receives DCI including a bandwidth part change indicator in slot n, the UE may complete a change to a new bandwidth part indicated by the bandwidth part change indicator at a time not later than slot n+T_{BWP}, and may transmit and receive the data channel scheduled by the corresponding DCI in the changed new bandwidth part. When the base station wants to schedule the data channel using the new bandwidth part, the base station may determine time domain resource assignment for the data channel in consideration of the bandwidth part change delay time T_{BWP} of the UE. That is, when the base station schedules the data channel using the new bandwidth part, in the method for determining time domain resource assignment for a data channel, the corresponding data channel may be scheduled after the bandwidth part change delay time. Accordingly, the UE may not expect the DCI indicating the bandwidth part change to indicate a slot offset (K0 or K2) value smaller than the bandwidth part change delay time T_{BWP}.

When the UE receives the DCI (e.g., DCI format 1_1 or 0_1) indicating the bandwidth part change, the UE may not perform any transmission or reception during a time interval from a third symbol of a slot in which the UE receives the PDCCH including the corresponding DCI to a start point of the slot indicated by the slot offset (K0 or K2) value indicated by a time domain resource assignment indicator field in the corresponding DCI. For example, when the UE receives the DCI indicating the bandwidth part change in slot n and the slot offset value indicated by the corresponding DCI is K, the UE may not perform any transmission or reception from a third symbol of slot n to a symbol (i.e., the last symbol of slot n+K−1) before slot n+K.

### [SS/PBCH Block]

Next, a synchronization signal (SS)/PBCH block in the 5G will be described.

The SS/PBCH block may mean a physical layer channel block composed of a primary SS (PSS), a secondary SS (SSS), and a PBCH. Specifically, the PSS, SSS, and PBCH are as follows.
PSS: The PSS is a signal that serves as a reference for downlink time/frequency synchronization and provides some information on a cell ID.
SSS: The SSS is a signal that serves as a reference for downlink time/frequency synchronization and provides the remaining cell ID information not provided by the PSS. Additionally, the SSS may serve as a reference signal for demodulating the PBCH.
PBCH: It provides essential system information required for transmission and reception of the data channel and the control channel of the UE. The essential system information may include search space-related control information indicating radio resource mapping information of the control channel, scheduling control information for a separate data channel transmitting system information, etc.
SS/PBCH block: The SS/PBCH block is composed of a combination of the PSS, SSS, and PBCH. One or a plurality of SS/PBCH blocks may be transmitted within 5 ms, and each SS/PBCH block transmitted may be distinguished by an index.

The UE may detect the PSS and SSS in the initial access stage, and decode the PBCH. The UE may acquire the MIB from the PBCH, and may be configured with control resource set (CORESET) #0 (which may correspond to a control resource set with a control resource set index of 0) from the acquired MIB. The UE may monitor the control resource set #0, assuming that the selected SS/PBCH block and a demodulation reference signal (DMRS) transmitted in the control resource set #0 are quasi co located (QCLed). The UE may receive the system information as the downlink control information transmitted in the control resource set #0. The UE may acquire a random access channel (RACH)-related configuration information required for the initial access from the received system information. The UE may transmit a physical RACH (PRACH) to the base station in consideration of the selected SS/PBCH index, and the base station receiving the PRACH may acquire information on the SS/PBCH block index selected by the UE. The base station may know which block of each SS/PBCH block the UE has selected and that the UE monitor the control resource set #0 associated with the selected block.

### [PDCCH: DCI Related]

Next, the downlink control information (DCI) in the 5G communication system will be described in detail.

In the 5G communication system, the scheduling information for uplink data (or physical uplink shared channel (PUSCH)) or downlink data (or physical downlink shared channel (PDSCH)) is transmitted from the base station to the UE by the DCI. The UE may monitor a fallback DCI format and a non-fallback DCI format for the PUSCH or the PDSCH. The fallback DCI format may be composed of a fixed field predefined between the base station and the UE, and the non-fallback DCI format may include a configurable field.

The DCI may be transmitted through a physical downlink control channel (PDCCH) by a channel coding and modulation process. A cyclic redundancy check (CRC), which is attached to a DCI message payload, may be scrambled by a radio network temporary identifier (RNTI) corresponding to a UE identity. Different RNTIs may be used depending on the purpose of the DCI message, such as UE-specific data transmission, power control command, or random access response. That is, the RNTI is not transmitted explicitly, but is transmitted by being included in a CRC calculation process. When receiving the DCI message transmitted on the PDCCH, the UE may identify the CRC using the allocated RNTI, and when the CRC identification result is correct, may know that the corresponding message was transmitted to the UE.

For example, DCI scheduling the PDSCH for the system information (SI) may be scrambled by an SI-RNTI. DCI scheduling the PDSCH for a random access response (RAR) message may be scrambled by an RA-RNTI. DCI scheduling the PDSCH for a paging message may be scrambled by a P-RNTI. DCI notifying a slot format indicator (SFI) may be scrambled by an SFI-RNTI. DC notifying transmit power control (TPC) may be scrambled by a TPC-RNTI. DCI scheduling a UE-specific PDSCH or PUSCH may be scrambled by a C-RNTI (cell RNTI).

DCI format 00 may be used as the fallback D scheduling the PUSCH. In this case, the CRC may be scrambled by a C-RNTI. The DCI format 00 with the CRC scrambled by the C-RNTI may include, for example, information of Table 4.

TABLE 4

| - | Identifier for DCI formats - [1] bit |
|---|---|
| - | Frequency domain resource assignment - |
| [┌log₂( N_{RB}^{UL,BWP} (N_{RB}^{UL,BWP} + 1)/2)┐ ] bits | |
| - | Time domain resource assignment - X bits |
| - | Frequency hopping flag - 1 bit. |
| - | Modulation and coding scheme - 5 bits |
| - | New data indicator - 1 bit |
| - | Redundancy version - 2 bits |
| - | HARQ process number - 4 bits |
| - | TPC command for scheduled PUSCH - [2] bits |
| - | UL/SUL indicator - 0 or 1 bit |

DCI format 0_1 may be used as the non-fallback DCI scheduling the PUSCH. In this case, the CRC may be scrambled by a C-RNTI. The DCI format 0_1 with the CRC scrambled by the C-RNTI may include, for example, information of Table 5.

TABLE 5

| - | Carrier indicator-0 or 3 bits | | |
|---|---|---|---|
| - | UL/SUL indicator-0 or 1 bit | | |
| - | Identifier for DCI formats-[1] bits | | |
| - | Bandwidth part indicator-0, 1 or 2 bits | | |
| - | Frequency domain resource assignment | | |
| | | • | $For resource allocation type 0 , ⌈ {N}_{RB}^{UL , BWP} / P ⌉ bits$ |
| | | • | $For resource allocation type 1 , ⌈ {log}_{2} ( {N}_{RB}^{UL , BWP} ( {N}_{RB}^{UL , BWP} + 1 ) / 2 ) ⌉ bits$ |
| - | Time domain resource assignment-1, 2, 3, or 4 bits | | |
| - | VRB-to-PRB mapping-0 or 1 bit, only for resource allocation type 1. | | |
| | | • | 0 bit if only resource allocation type 0 is configured; |
| | | • | 1 bit otherwise. |
| - | Frequency hopping flag-0 or 1 bit, only for resource allocation type 1. | | |
| | | • | 0 bit if only resource allocation type 0 is configured; |
| | | • | 1 bit otherwise. |
| - | Modulation and coding scheme-5 bits | | |
| - | New data indicator-1 bit | | |
| - | Redundancy version-2 bits | | |
| - | HARQ process number-4 bits | | |
| - | 1st downlink assignment index-1 or 2 bits | | |
| | | • | 1 bit for semi-static HARQ-ACK codebook; |
| | | • | 2 bits for dynamic HARQ-ACK codebook with single HARQ-ACK |
| | | | codebook. |
| - | 2nd downlink assignment index-0 or 2 bits | | |
| | | • | 2 bits for dynamic HARQ-ACK codebook with two HARQ-ACK |
| | | | sub-codebooks; |
| | | • | 0 bit otherwise. |
| - | TPC command for scheduled PUSCH-2 bits | | |
| - | $SRS resource indicator - ⌈ {log}_{2} ( {\sum }_{k = 1}^{{L}_{max}} ( \begin{matrix}{N}_{SRS} \\ k\end{matrix} ) ) ⌉ or ⌈ {log}_{2} ( {N}_{SRS} ) ⌉ bits$ | | |
| | | • | $⌈ {log}_{2} ( {\sum }_{k = 1}^{{L}_{max}} ( \begin{matrix}{N}_{SRS} \\ k\end{matrix} ) ) ⌉ bits for non - codebook based PUSCH transmission ;$ |
| | | • | ┌log₂(N_{SRS})┐ bits for codebook based PUSCH transmission. |

| | |
|---|---|
| - | Precoding information and number of layers-up to 6 bits |
| - | Antenna ports-up to 5 bits |
| - | SRS request-2 bits |
| - | CSI request-0, 1, 2, 3, 4, 5, or 6 bits |
| - | CBG transmission information-0, 2, 4, 6, or 8 bits |
| - | PTRS-DMRS association-0 or 2 bits. |
| - | beta_offset indicator-0 or 2 bits |
| - | DMRS sequence initialization-0 or 1 bit |

DCI format 1_0 may be used as the fallback DCI scheduling the PDSCH. In this case, the CRC may be scrambled by the C-RNTI. The DCI format 1_0 with the CRC scrambled by the C-RNTI may include, for example, information of Table 6.

TABLE 6

| - | Identifier for DCI formats - [1] bit |
|---|---|
| - | Frequency domain resource assignment - |
| [┌log₂( N_{RB}^{DL,BWP} (N_{RB}^{DL,BWP} + 1)/2)┐ ] bits | |
| - | Time domain resource assignment - X bits |
| - | VRB-to-PRB mapping - 1 bit. |
| - | Modulation and coding scheme - 5 bits |
| - | New data indicator - 1 bit |
| - | Redundancy version - 2 bits |
| - | HARQ process number - 4 bits |
| - | Downlink assignment index - 2 bits |
| - | TPC command for scheduled PUCCH - [2] bits |
| - | PUCCH resource indicator - 3 bits |
| - | PDSCH-to-HARQ feedback timing indicator - [3] bits |

DCI format 1_1 may be used as the non-fallback DCI scheduling the PDSCH. In this case, the CRC may be scrambled by the C-RNTI. The DCI format 1_1 with the CRC scrambled by the C-RNTI may include, for example, information of Table 7.

TABLE 7

| - | Carrier indicator - 0 or 3 bits | |
|---|---|---|
| - | Identifier for DCI formats - [1] bits | |
| - | Bandwidth part indicator - 0, 1 or 2 bits | |
| - | Frequency domain resource assignment | |
| | • | For resource allocation type 0, ┌N_{RB}^{DL,BWP} /P┐ bits |
| | • | For resource allocation type 1, |
| | | ┌log₂( N_{RB}^{DL,BWP} (N_{RB}^{DL,BWP} + 1)/2)┐ bits |
| - | Time domain resource assignment -1, 2, 3, or 4 bits | |
| - | VRB-to-PRB mapping - 0 or 1 bit, only for | |
| | resource allocation type 1. | |
| | • | 0 bit if only resource allocation type 0 is configured; |
| | • | 1 bit otherwise. |

| | |
|---|---|
| - | PRB bundling size indicator - 0 or 1 bit |
| - | Rate matching indicator - 0, 1, or 2 bits |
| - | ZP CSI-RS trigger - 0, 1, or 2 bits |

For transport block 1:

| | |
|---|---|
| - | Modulation and coding scheme - 5 bits |
| - | New data indicator - 1 bit |
| - | Redundancy version - 2 bits |

For transport block 2:

| | |
|---|---|
| - | Modulation and coding scheme - 5 bits |
| - | New data indicator - 1 bit |
| - | Redundancy version - 2 bits |
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ_feedback timing indicator - 3 bits |
| - | Antenna ports - 4, 5 or 6 bits |
| - | Transmission configuration indication - 0 or 3 bits |
| - | SRS request - 2 bits |
| - | CBG transmission information - 0, 2, 4, 6, or 8 bits |
| - | CBG flushing out information - 0 or 1 bit |
| - | DMRS sequence initialization - 1 bit |

### [PDCCH: CORESET, REG, CCE, Search Space]

The downlink control channel in the 5G communication system will be described below in more detail with reference to the drawings.

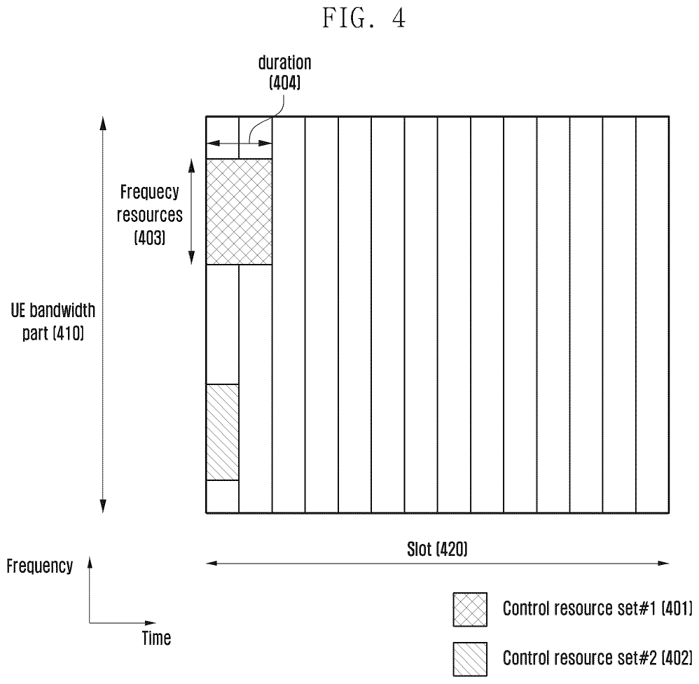

FIG. 4 is a drawing illustrating an example of the control resource set (CORESET) in which the downlink control channel is transmitted in the 5G wireless communication system according to an embodiment of the disclosure.

FIG. 4 illustrates an example in which two control resource sets (control resource set #1 401 and control resource set #2 402) are configured in a UE bandwidth part 410 on a frequency-domain and 1 slot 420 on a time-domain. The control resource sets 401 and 402 may be configured to a specific frequency resource 403 within the entire UE bandwidth part 410 on the frequency-domain. One or a plurality of OFDM symbols may be configured on the time-domain, which may be defined as a control resource set duration 404. Referring to the illustrated example of FIG. 4, control resource set #1 401 is configured to a control resource set duration of 2 symbols, and control resource set #2 402 is configured to a control resource set duration of 1 symbol.

The control resource set in the above-described 5G may be configured by the base station for the UE by the higher layer signaling (e.g., system Information, master information block (MIB), radio resource control (RRC) signaling). Configuring the control resource set for the UE refers to providing information such as a control resource set identity, a frequency position of the control resource set, and a symbol duration of the control resource set. For example, the control resource set may include information of Table 8.

TABLE 8

| | |
|---|---|
| ControlResourceSet ::= | SEQUENCE { |

-- Corresponds to L1 parameter ‘CORESET-ID’

| | |
|---|---|
| controlResourceSetId | ControlResourceSetId, |

(control resource set identity)

| | |
|---|---|
| frequencyDomainResources | BIT STRING (SIZE (45)), |

(frequency-domain resource allocation information)

| | |
|---|---|
| duration | INTEGER (1..maxCoReSetDuration), |

(time-domain resource allocation information)

| | |
|---|---|
| cce-REG-MappingType | CHOICE { |

(CCE-to-REG mapping scheme)

| | |
|---|---|
| interleaved | SEQUENCE { |
| reg-BundleSize | ENUMERATED {n2, n3, n6}, |

(REG bundle size)

| | |
|---|---|
| precoderGranularity | ENUMERATED |

{sameAsREG-bundle, allContiguousRBs},

| | |
|---|---|
| interleaverSize | ENUMERATED {n2, n3, n6} |

```
      (interleaver size)
      shiftIndex
      INTEGER(0..maxNrofPhysicalResourceBlocks-1)
        OPTIONAL
      (interleaver shift)
    },
```

| | |
|---|---|
| nonInterleaved | NULL |

},

| | |
|---|---|
| tci-StatesPDCCH | SEQUENCE(SIZE |

```
    (1..maxNrofTCI-StatesPDCCH)) OF TCI-StateId
      OPTIONAL,
  (QCL configuration information)
```

| | |
|---|---|
| tci-PresentInDCI | ENUMERATED {enabled} |
| | OPTIONAL, -- Need S |

}

In Table 8, tci-StatesPDCCH (simply named as transmission configuration indication (TCI) state) configuration information may include information on one or more synchronization signal (SS)/physical broadcast channel (PBCH) block indexes or channel state information reference signal (CSI-RS) indexes that are in a quasi co located (QCLed) relationship with the DMRS transmitted in the corresponding control resource set.

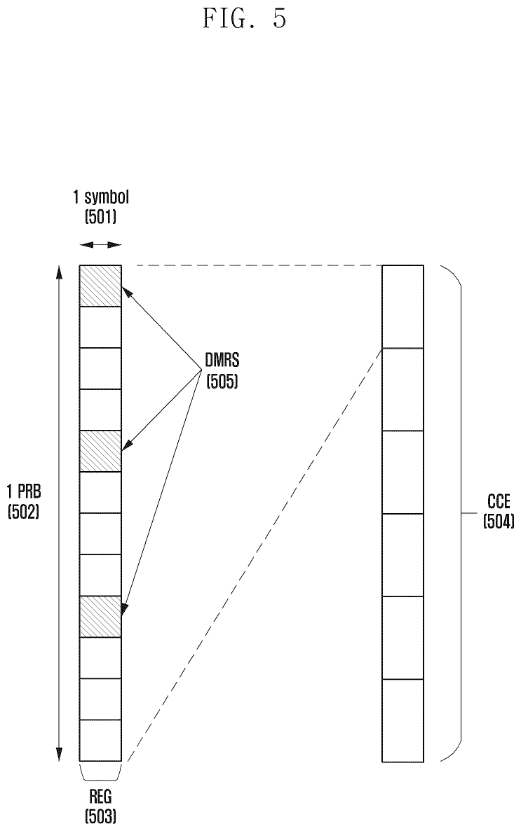

FIG. 5 is a diagram illustrating an example of a basic unit of time and frequency resources that constitute the downlink control channel that may be used in the 5G according to an embodiment of the disclosure.

Referring to FIG. 5, the basic unit of the time and frequency resources that constitute the control channel may be referred to as a resource element group (REG) 503, and the REG 503 may be defined as 1 OFDM symbol 501 on the time-domain and 1 physical resource block (PRB) 502 on the frequency-domain, i.e., 12 subcarriers. The base station may configure a downlink control channel allocation unit by concatenating the REGs 503.

Referring to FIG. 5, when the basic unit to which the downlink control channel is allocated in the 5G is referred to as a control channel element (CCE) 504, 1 CCE 504 may be composed of the plurality of REGs 503. Describing the REG 503 illustrated in FIG. 5 as an example, the REG 503 may be composed of 12 REs, and when the 1 CCE 504 is composed of 6 REGs 503, the 1 CCE 504 may be composed of 72 REs. When the downlink control resource set is configured, the corresponding area may be composed of the plurality of CCEs 504, and a specific downlink control channel may be mapped and transmitted to one or more CCEs 504 according to an aggregation level (AL) in the control resource set. The CCEs 504 in the control resource set are distinguished by numbers. In this case, the numbers of the CCEs 504 may be assigned according to a logical mapping method.

The basic unit of the downlink control channel, i.e., the REG 503 illustrated in FIG. 5, may include both REs to which the DCI is mapped and areas to which a DMRS 505, which is a reference signal for decoding the REs, is mapped. As illustrated in FIG. 5, three DMRSs 505 may be transmitted in 1 REG 503. The number of CCEs required to transmit the PDCCH may be 1, 2, 4, 8, or 16 depending on the aggregation level (AL), and different numbers of CCEs may be used to implement link adaptation of the downlink control channel. For example, when AL=L, one downlink control channel may be transmitted through L CCEs. The UE should detect a signal without knowing the information on the downlink control channel, and a search space representing a set of CCEs for blind decoding is defined. The search space is a set of downlink control channel candidates composed of the CCEs that the UE should attempt to decode on the given aggregation level, and since there are various aggregation levels that make a single bundle with 1, 2, 4, 8, and 16 CCEs, the UE may have a plurality of search spaces. A search space set may be defined as a set of search spaces at all configured aggregation levels.

The search space may be classified into a common search space and a UE-specific search space. A certain group of UEs or all UEs may search for the common search space of the PDCCH to receive cell-common control information such as dynamic scheduling for the system information or the paging message. For example, the PDSCH scheduling allocation information for transmission of the SIB including operator information of a cell may be received by searching for the common search space of the PDCCH. For the common search space, since a certain group of UEs or all the UEs should receive the PDCCH, the common search space may be defined as a set of pre-promised CCEs. The scheduling allocation information for the UE-specific PDSCH or PUSCH may be received by searching for the UE-specific search space of the PDCCH. The UE-specific search space may be defined UE-specifically as a function of the UE identity and various system parameters.

In the 5G, parameters of the search space for the PDCCH may be configured for the UE by the base station by using the higher layer signaling (e.g., SIB, MIB, and RRC signaling). For example, the base station may configure, for the UE, the number of PDCCH candidates at each aggregation level L, the monitoring periodicity for the search space, the monitoring occasion for each symbol in the slot for the search space, the search space type (common search space or UE-specific search space), a combination of the DCI format and the RNTI to be monitored in the corresponding search space, the control resource set index to monitor the search space, etc. For example, the search space may include information of Table 9.

TABLE 9

| | |
|---|---|
| SearchSpace ::= | SEQUENCE { |

```
  -- Identity of the search space. SearchSpaceId = 0 identifies the SearchSpace
    configured via PBCH (MIB) or ServingCellConfigCommon.
```

| | |
|---|---|
| searchSpaceId | SearchSpaceId, |

(search space identity)

| | |
|---|---|
| controlResourceSetId | ControlResourceSetId, |

(control resource set identity)

| | |
|---|---|
| monitoringSlotPeriodicityAndOffset | CHOICE { |

(monitoring slot level periodicity)

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |

}

| | |
|---|---|
| | OPTIONAL, |
| duration(monitoring duration) | INTEGER (2..2559) |
| monitoringSymbolsWithinSlot | BIT STRING (SIZE (14)) |
| | OPTIONAL, |

(monitoring symbol within slot)

| | |
|---|---|
| nrofCandidates | SEQUENCE { |

(number of PDCCH candidates for each aggregation level)

| | |
|---|---|
| aggregationLevel1 | ENUMERATED {n0, n1, n2, n3, |

n4, n5, n6, n8},

| | |
|---|---|
| aggregationLevel2 | ENUMERATED {n0, n1, n2, n3, |

n4, n5, n6, n8},

| | |
|---|---|
| aggregationLevel4 | ENUMERATED {n0, n1, n2, n3, |

n4, n5, n6, n8},

| | |
|---|---|
| aggregationLevel8 | ENUMERATED {n0, n1, n2, n3, |

n4, n5, n6, n8},

| | |
|---|---|
| aggregationLevel16 | ENUMERATED {n0, n1, n2, n3, |

```
    n4, n5, n6, n8}
  },
```

| | |
|---|---|
| searchSpaceType | CHOICE { |

```
  (search space type)
    -- Configures this search space as common search space (CSS) and DCI
    formats to monitor.
```

| | |
|---|---|
| common | SEQUENCE { |

```
  (common search space)
    }
```

| | |
|---|---|
| ue-Specific | SEQUENCE { |

```
  (UE-specific search space)
      -- Indicates whether the UE monitors in this USS for DCI formats 0-0
    and 1-0 or for formats 0-1 and 1-1.
```

| | |
|---|---|
| formats | ENUMERATED {formats0-0- |

```
    And-1-0, formats0-1-And-1-1},
      ...
    }
```

According to the configuration information, the base station may configure one or more search space sets for the UE. According to some embodiments, the base station may configure search space set 1 and search space set 2 for the UE, and may configure DCI format A scrambled by an X-RNTI in the search space set 1 to be monitored in the common search space and configure DCI format B scrambled by a Y-RNTI in the search space set 2 to be monitored in the UE-specific search space.

According to the configuration information, one or more search space sets may exist in the common search space or the UE-specific search space. For example, search space set #1 and search space set #2 may be configured as the common search space, and search space set #3 and search space set #4 may be configured as the UE-specific search space.

In the common search space, the following combinations of the DCI formats and the RNTIs may be monitored. Of course, the combinations are not limited to the following example.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In the UE-specific search space, the following combinations of the DCI formats and the RNTIs may be monitored. Of course, the combinations are not limited to the following example.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The specified RNTIs may follow the definitions and uses below.
Cell RNTI (C-RNTI): For UE-specific PDSCH scheduling
Temporary Cell RNTI (TC-RNTI): For UE-specific PDSCH scheduling
Configured Scheduling RNTI (CS-RNTI): For UE-specific PDSCH scheduling configured semi-statically
Random Access RNTI (RA-RNTI): For PDSCH scheduling in random access stage
Paging RNTI (P-RNTI): For PDSCH scheduling to transmit paging
System Information RNTI (SI-RNTI): For PDSCH scheduling to transmit system information
Interruption RNTI (INT-RNTI): For notifying whether puncturing is performed on PDSCH
Transmit Power Control for PUSCH RNTI (TPC-PUSCH-RNTI): For power control command indication for PUSCH
Transmit Power Control for PUCCH RNTI (TPC-PUCCH-RNTI): For power control command indication for PUCCH
Transmit Power Control for SRS RNTI (TPC-SRS-RNTI): For power control command indication for SRS

The specified DCI formats described above may follow the definitions as in the example in Table 10.

TABLE 10

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM symbol(s) |
| | where UE may assume no transmission is intended for the UE |
| 2_2 | Transmission of TPC commands for PUCCH and PUSCH |
| 2_3 | Transmission of a group of TPC commands for SRS |
| | transmissions by one or more UEs |

In the 5G, the search spaces of the aggregation levels L in control resource set p and search space set s may be expressed as illustrated in Equation 1.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad Equation 1$$

L: Aggregation level
n_{CI}: Carrier index
N_{CCE,p}: Total number of CCEs existing in control resource set p
n_{s,f}^{μ}: Slot index
M_{s,max}^{(L)}: Number of PDCCH candidates of carrier level L
m_{s,n}_{_{CI}}=0, . . . , M_{s,max}^{(L)}−1: PDCCH candidate index of aggregation level L
i=0, . . . , L−1

$${Y}_{p , {n}_{s , f}^{μ}} = ( {A}_{p} \cdot {Y}_{p , {n}_{s , f}^{μ} - 1} ) mod D ,$$

Y_{p,-1}=n_{RNTI}≠0, Aₚ=39827 for p mod 3=0, Aₚ=39829 for p mod 3=1, A_{R}=39839 for p mod 3=2, D=65537
n_{RNTI}: UE identity

$${Y}_{p , {n}_{s , f}^{μ}}$$

value may correspond to 0 for common search space.

$${Y}_{p , {n}_{s , f}^{μ}}$$

value may correspond to value varying depending on UE identity (ID configured to UE by C-RNTI or base station) and time index for UE-specific search space.

In the 5G, as the plurality of search space sets may be configured with different parameters (e.g., parameters in Table 9), a set of search space sets monitored by the UE at each time point may be different. For example, when the search space set #1 is configured to an X-slot cycle, the search space set #2 is configured to a Y-slot cycle, and X and Y are different, the UE may monitor both the search space set #1 and the search space set #2 in a specific slot and monitor either the search space set #1 or the search space set #2 in the specific slot.

[Rate matching/Puncturing Related]

A rate matching operation and a puncturing operation will be described below in detail.

When time and frequency resource A, which intends to transmit random symbol sequence A, overlaps with random time and frequency resource B, the rate matching or puncturing operation may be considered as a transmission and reception operation of channel A that considers resource C in an area where resource A and resource B overlap with each other. The specific operation may follow the contents below.

### Rate Matching Operation

The base station may map the channel A only to the remaining resource areas of the entire resources A that want to transmit the symbol sequence A to the UE, excluding the resource C corresponding to an area overlapping with the resource B, and transmit the channel A. For example, when the symbol sequence A is composed of {symbol #1, symbol #2, symbol #3, symbol 4}, the resource A is composed of {resource #1, resource #2, resource #3, resource #4}, and the resource B is composed of {resource #3, resource #5}, the base station may sequentially map the symbol sequence A to {resource #1, resource #2, resource #4}, which are the remaining resources of the resources A excluding {resource #3} corresponding to the resource C, and transmit the symbol sequence A. As a result, the base station may map symbol sequences {symbol #1, symbol #2, symbol #3} to {resource #1, resource #2, resource #4}, respectively, and transmit the symbol sequences {symbol #1, symbol #2, symbol #3}.

The UE may determine the resources A and B from the scheduling information for the symbol sequence A by the base station, and may thus determine the resource C, which is an area where the resources A and B overlap with each other. The UE may receive the symbol sequence A, assuming that the symbol sequence A is mapped to the remaining areas of the entire resources A excluding the resource C, and transmitted. For example, when the symbol sequence A is composed of {symbol #1, symbol #2, symbol #3, symbol 4}, the resource A is composed of {resource #1, resource #2, resource #3, resource #4}, and the resource B is composed of {resource #3, resource #5}, the UE may receive the symbol sequence A, assuming that the symbol sequence A is sequentially mapped to {resource #1, resource #2, resource #4}, which are the remaining resources of the resources A excluding {resource #3} corresponding to the resource C. As a result, the UE may perform a series of subsequent reception operations, assuming that symbol sequences {symbol #1, symbol #2, symbol #3} are mapped to {resource #1, resource #2, resource #4}, respectively, and transmitted.

### Puncturing Operation

When there is the resource C corresponding to an area overlapping with the resource B among the entire resources A that want to transmit the symbol sequence A to the UE, the base station maps the symbol sequence A to the entire resources A but does not perform transmission in the resource area corresponding to the resource C, and may perform transmission only for the remaining resource areas of the resources A excluding the resource C. For example, when the symbol sequence A is composed of {symbol #1, symbol #2, symbol #3, symbol #4}, the resource A is composed of {resource #1, resource #2, resource #3, resource #4}, and the resource B is composed of {resource #3, resource #5}, the base station may map the symbol sequence A {symbol #1, symbol #2, symbol #3, symbol #4} to the resource A {resource #1, resource #2, resource #3, resource #4}, respectively, and transmit only symbol sequences {symbol #1, symbol #2, symbol #4} corresponding to the remaining resources {resource #1, resource #2, resource #4} of the entire resources A excluding {resource #3} corresponding to the resource C, and may not transmit {symbol #3} mapped to {resource #3} corresponding to the resource C. As a result, the base station may map symbol sequences {symbol #1, symbol #2, symbol #4} to {resource #1, resource #2, resource #4}, respectively, and transmit the symbol sequences {symbol #1, symbol #2, symbol #4}.

The UE may determine the resources A and B from the scheduling information for the symbol sequence A by the base station, and may thus determine the resource C, which is an area where the resources A and B overlap with each other. The UE may receive the symbol sequence A, assuming that the symbol sequence A is mapped to the entire resource A, but is transmitted only in the remaining areas of the resource area A excluding the resource C. For example, when the symbol sequence A is composed of {symbol #1, symbol #2, symbol #3, symbol #4}, the resource A is composed of {resource #1, resource #2, resource #3, resource #4}, and the resource B is composed of {resource #3, resource #5}, the terminal may assume that the symbol sequence A {symbol #1, symbol #2, symbol #3, symbol #4} is mapped to resource A {resource #1, resource #2, resource #3, resource #4}, respectively, but {symbol #3} mapped to {resource #3} corresponding to resource C is not transmitted, and may receive the symbol sequence A {symbol #1, symbol #2, symbol #3, symbol #4}, assuming that the symbol sequences {symbol #1, symbol #2, symbol #4} corresponding to the remaining resources {resource #1, resource #2, resource #4}, excluding {resource #3} corresponding to the resource C among the resource A, are mapped and transmitted. As a result, the UE may perform a series of subsequent reception operations, assuming that symbol sequences {symbol #1, symbol #2, symbol #4} are mapped to {resource #1, resource #2, resource #4}, respectively, and transmitted.

A method for configuring a rate matching resource for rate matching of a communication system will be described below. The rate matching means that a size of a signal is adjusted in consideration of the amount of resources that may transmit the signal. For example, the rate matching of the data channel may mean that a size of data is adjusted without mapping the data channel to a specific time and frequency resource area and transmitting the data channel.

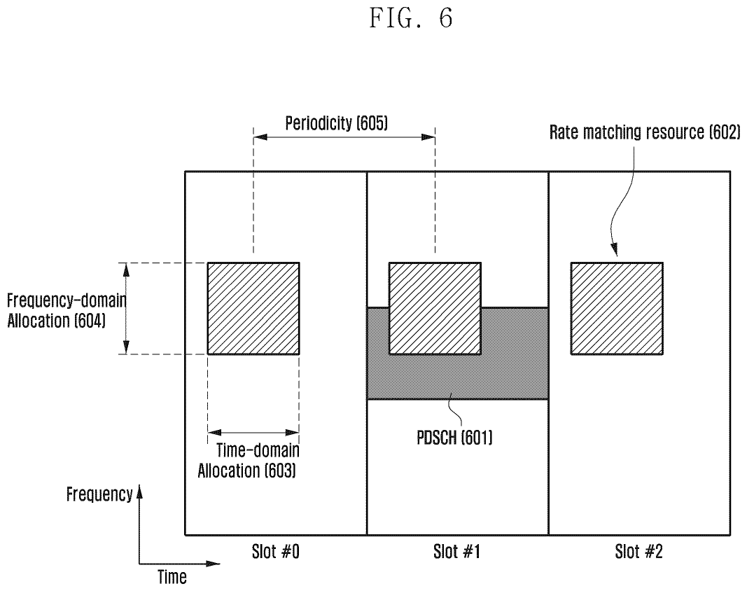

FIG. 6 is a diagram for describing a method for a base station and a UE to transmit and receive data in consideration of a downlink data channel and a rate matching resource according to an embodiment of the disclosure.

FIG. 6 illustrates a downlink data channel (PDSCH) 601 and a rate matching resource 602. The base station may configure one or more rate matching resources 602 for the UE by the higher layer signaling (e.g., RRC signaling). The configuration information of the rate matching resource 602 may include time-domain resource allocation information 603, frequency-domain resource allocation information 604, and periodicity information 605. In the following, a bitmap corresponding to the frequency-domain resource allocation information 604 is named a “first bitmap,” a bitmap corresponding to the time-domain resource allocation information 603 is named a “second bitmap”, and a bitmap corresponding to the periodicity information 605 is named a “third bitmap.” When all or part of the time and frequency resources of the scheduled data channel 601 overlap with the configured rate matching resource 602, the base station may rate-match the data channel 601 to the rate matching resource 602 part and transmit the data channel 601, and the UE may receive and decode the data channel 601, after assuming that the data channel 601 is rate-matched to the rate matching resource 602 part.

The base station may use the DCI to dynamically notify the UE whether to rate-match the data channel to the configured rate matching resource part through additional configuration (corresponding to a “rate matching indicator” in the DCI format described above). Specifically, the base station may select some of the configured rate matching resources and group the selected rate matching resources into rate matching resource groups, and use a bitmap scheme to indicate to the UE whether to rate-match the data channel for each rate matching resource group by the DCI. For example, when four rate matching resources, RMR #1, RMR #2, RMR #3, and RMR #4, are configured, the base station may configure RMG #1={RMR #1, RMR #2} and RMG #2={RMR #3, RMR #4} as the rate matching group, and may use 2 bits in a DCI field to indicate to the UE whether to rate-match in the RMG #1 and the RMG #2, respectively, by the bitmap. For example, the case where the rate matching needs to be performed may be indicated by “1”, and the case where the rate matching need not be performed may be indicated by “0”.

The above-described method for configuring a rate matching resource for a UE supports granularities of a “RB symbol level” and a “RE level.” More specifically, the following configuration method may be followed.

### RB Symbol Level

The UE may be configured with up to four ratematchpatterns for each bandwidth part by higher layer signaling, and one ratematchpattern may include the following contents.

Examples of a reserved resource in a bandwidth part may include a resource in which time and frequency resource areas of the corresponding reserved resource are configured by combining a bitmap of the RB level and a bitmap of the symbol level on the frequency-domain. The reserved resource may span one or two slots. A time domain pattern (periodicityandpattern) in which the time and frequency areas composed of each RB level and symbol level bitmap pair are repeated may be additionally configured.

A resource area corresponding to a time and frequency domain resource area configured as a control resource set in the bandwidth part and a time domain pattern configured as a search space configuration in which the corresponding resource area is repeated may be included.

### RE Level

The UE may be configured with the following contents by the higher layer signaling.

Examples of configuration information (lte-CRS-ToMatchAround) of RE corresponding to an LTE CRS (cell-specific reference signal or common reference signal) pattern may include the number of ports (nrofCRS-Ports) of LTE CRS and a value (v-shift) of LTE-CRS-vshift(s), location information (carrierfreqDL) of a center subcarrier of LTE carrier from a frequency point (e.g., reference point A) as a reference, bandwidth size (carrierBandwidthDL) information of an LTE carrier, subframe configuration information (mbsfn-SubframConfigList) corresponding to a multicast-broadcast single-frequency network (MBSFN), etc. The UE may determine a CRS position within an NR slot corresponding to an LTE subframe based on the above-described information.

Configuration information of a resource set corresponding to one or more zero power (ZP) CSI-RSs in a bandwidth part may be included.

### [PDSCH: Frequency Resource Allocation Related]

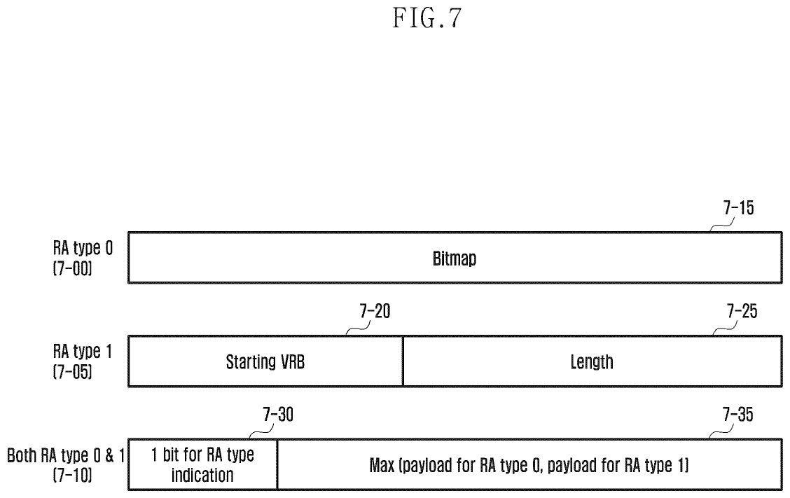

FIG. 7 is a diagram illustrating an example of the frequency-domain resource allocation of the physical downlink shared channel (PDSCH) in the wireless communication system according to an embodiment of the disclosure.

FIG. 7 is a diagram illustrating three frequency-domain resource allocation methods, type 0 7-00, type 1 7-05, and dynamic switch (7-10), which can be configured through a higher layer in an NR wireless communication system.

Referring to FIG. 7, when the UE is configured to use only the resource type 0 7-00 by the higher layer signaling, some downlink control information (DCI) that allocates the PDSCH to the corresponding UE includes a bitmap composed of NRBG bits. The conditions for this will be described below. In this case, the NRBG refers to the number of resource block groups (RBGs) determined according to a BWP size allocated by a BWP indicator and a higher layer parameter rbg-Size as illustrated in Table 11 below, and data is transmitted to the RBG indicated as 1 by the bitmap.

TABLE 11

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

When the UE is configured to use only resource type 1 7-05 by the higher layer signaling, some DCI that allocates the PDSCH to the corresponding UE include frequency-domain resource allocation information composed of ┌log₂(N_{RB}^{DL,BWP}(N_{RB}^{DL,BWP}+1)/2┐ bits. The conditions for this will be described again later. Through this, the base station may configure a starting VRB 7-20 and a length 7-25 of a frequency-domain resource that is allocated consecutively therefrom.

When the UE is configured to use both the resource type 0 and resource type 1 by the higher layer signaling (7-10), some DCI that allocates the PDSCH to the corresponding UE includes frequency-domain resource allocation information composed of bits with the larger value (7-35) of a payload (7-15) for configuring the resource type 0 and payloads (7-20 and 7-25) for configuring the resource type 1. The conditions for this will be described again later. In this case, one bit (7-30) may be added to a first part (MSB) of the frequency-domain resource allocation information in the DCI, and when the corresponding bit has a value of ‘0’, it is indicated that the resource type 0 is used, and when the corresponding bit has a value of ‘1’, it is indicated that the resource type 1 is used.

### [PDSCH/PUSCH: Time Resource Allocation Related]

Hereinafter, a time domain resource assignment method for a data channel in a next-generation mobile communication system (5G or NR system) will be described.

The base station may configure a table for the time domain resource assignment information for the downlink data channel (physical downlink shared channel (PDSCH) and the uplink data channel (physical uplink shared channel (PUSCH) for the UE by the higher layer signaling (e.g., RRC signaling). For the PDSCH, a table composed of up to maxNrofDL-Allocations=16 entries may be configured, and for the PUSCH, a table composed of up to maxNrofUL-Allocations=16 entries may be configured. In an embodiment, the time domain resource assignment information may include PDCCH-to-the PDSCH slot timing (corresponding to a slot-unit time interval between a time point when the PDCCH is received and a time point when the PDSCH scheduled by the received PDCCH is transmitted, which is denoted by K0), PDCCH-to-the PUSCH slot timing (corresponding to a slot-unit time interval between a time point when the PDCCH is received and a time point when the PUSCH scheduled by the received PDCCH is transmitted, which is denoted by K2), information on a position and duration of a start symbol in which the PDSCH or the PUSCH is scheduled within a slot, a mapping type of the PDSCH or the PUSCH, etc. For example, the information such as Table 12 or Table 13 below may be transmitted from the base station to the UB.

TABLE 12
PDSCH-TimeDomainResourceAllocationList information element

| | |
|---|---|
| PDSCH-TimeDomainResourceAllocationList ::= | SEQUENCE (SIZE(1..maxNrofDL-Allocations)) OF PDSCH- |

TimeDomainResourceAllocation

| | |
|---|---|
| PDSCH-TimeDomainResourceAllocation ::= | SEQUENCE { |
| k0 | INTEGER(0..32) OPTIONAL, -- Need |

S
(PDCCH-to-PDSCH timing, slot unit)

| | |
|---|---|
| mappingType | ENUMERATED {typeA, typeB}, |

(PDSCH mapping type)

| | |
|---|---|
| startSymbolAndLength | INTEGER (0..127) |

(start symbol and length of PDSCH)
}

TABLE 13
PUSCH-TimeDomainResourceAllocation information element

| | |
|---|---|
| PUSCH-TimeDomainResourceAllocationList ::= | SEQUENCE (SIZE(1..maxNrofUL-Allocations)) OF PUSCH- |

TimeDomainResourceAllocation

| | |
|---|---|
| PUSCH-TimeDomainResourceAllocation ::= | SEQUENCE { |
| k2 | INTEGER(0..32) OPTIONAL, -- Need S |

(PDCCH-to-PUSCH timing, slot unit)

| | |
|---|---|
| mappingType | ENUMERATED {typeA, typeB}, |

(PUSCH mapping type)

| | |
|---|---|
| startSymbolAndLength | INTEGER (0..127) |

(start symbol and length of PUSCH)
}

The base station may notify the UE of one of the entries in the table for the time domain resource assignment information described above by L1 signaling (e.g., DCI) (e.g., which may be indicated by a ‘time domain resource assignment’ field in the DCI). The UE may acquire the time domain resource assignment information for the PDSCH or the PUSCH based on the DCI received from the base station.

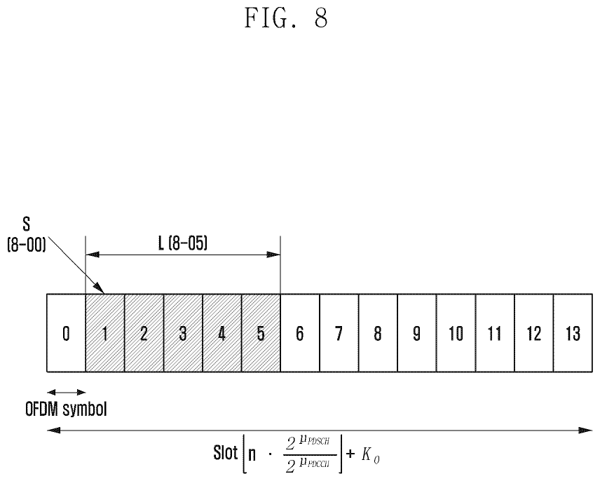

FIG. 8 is a diagram illustrating an example of the time-domain resource allocation of the PDSCH in the wireless communication system according to an embodiment of the disclosure.

Referring to FIG. 8, the base station may indicate the time-domain position of the PDSCH resource according to the subcarrier spacings (SCS) (μPDSCH, μPDCCH) of the data channel and the control channel configured by using the higher layer, the scheduling offset (K0) value, and an OFDM symbol start position 8-00 and length 8-05 within one slot that are dynamically indicated by the DCI.

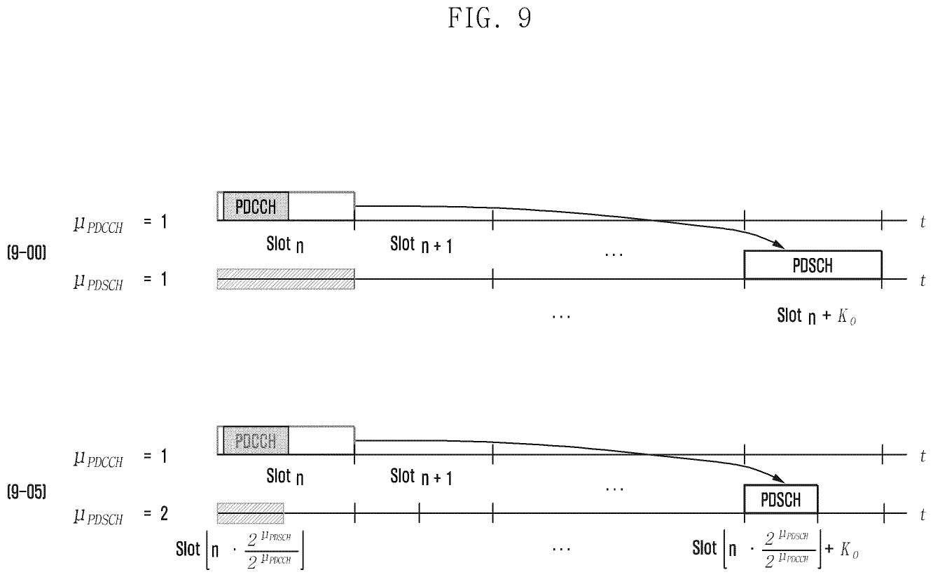

FIG. 9 is a diagram illustrating an example of the time-domain resource allocation according to the subcarrier spacings of the data channel and the control channel in the wireless communication system according to an embodiment of the disclosure.

Referring to FIG. 9, when the subcarrier spacings of the data channel and the control channel are the same (9-00, μPDSCH=μPDCCH), slot numbers for data and control are the same, so the base station and the UE may generate a scheduling offset according to a predetermined slot offset K0. On the other hand, when the subcarrier spacings of the data channel and the control channel are different (9-05, μPDSCH #μPDCCH), the slot numbers for the data and control are different, so the base station and the UE may generate the scheduling offset according to the predetermined slot offset K0 based on the subcarrier spacing of the PDCCH.

### [PUSCH: Transmission Scheme Related]

Next, a scheduling scheme for PUSCH transmission will be described. The PUSCH transmission may be dynamically scheduled by UL grant with the DCI, or operated by configured grant Type 1 or Type 2. The dynamic scheduling indication for the PUSCH transmission is possible with the DCI format 0_0 or 0_1.

The configured grant Type 1 PUSCH transmission may be semi-statically set by receiving configuredGrantConfig including rrc-ConfiguredUplinkGrant of Table 14 by the higher layer signaling without receiving the UL grant in the DCI. The configured grant Type 2 PUSCH transmission may be semi-persistently scheduled by the UL grant in DCI after receiving configuredGrantConfig not including rrc-ConfiguredUplinkGrant of Table 14 by the higher layer signaling. When the PUSCH transmission operates by the configured grant, parameters applied to the PUSCH transmission are applied through configuredGrantConfig that is the higher layer signaling of Table 14, except for dataScramblingIdentityPUSCH, txConfig, codebookSubset, maxRank, and scaling of UCI-OnPUSCH provided by pusch-Config of Table 15 that is the higher layer signaling. When the UE is provided with transformPrecoder in the configuredGrantConfig that is the higher layer signaling of Table 14, the UE applies tp-pi2BPSK within the pusch-Config of Table 15 for the PUSCH transmission operated by the configured grant.

TABLE 14

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, sym4x14, sym5x14, |

sym8x14, sym10x14, sym16x14, sym20x14,

sym32x14, sym40x14, sym64x14, sym80x14,

sym128x14, sym160x14, sym256x14, sym320x14, sym512x14,

sym640x14, sym1024x14, sym1280x14, sym2560x14,

sym5120x14,

sym6, sym1x12, sym2x12, sym4x12, sym5x12,

sym8x12, sym10x12, sym16x12, sym20x12, sym32x12,

sym40x12, sym64x12, sym80x12, sym128x12,

sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. |
| maxNrofPhysicalResourceBlocks-1) | OPTIONAL, -- Need R |
| pathlossReferenceIndex | INTEGER (0..maxNrofPUSCH- |

PathlossReferenceRSs-1),

| | |
|---|---|
| ... | OPTIONAL, |

```
  }
-- Need R
  ...
}
```

Next, a PUSCH transmission method will be described. A DMRS antenna port for the PUSCH transmission is the same as an antenna port for SRS transmission. The PUSCH transmission may follow a codebook-based transmission method and a non-codebook-based transmission method, respectively, depending on whether a value of the txConfig in the pusch-Config of Table 15, which is the higher layer signaling, is ‘codebook’ or ‘nonCodebook’.

As described above, the PUSCH transmission may be dynamically scheduled by the DCI format 0_0 or 0_1, and configured semi-statically by the configured grant. If the UE is indicated to schedule the PUSCH transmission by the DCI format 0_0, the UE performs a beam configuration for the PUSCH transmission using pucch-spatialRelationInfoID corresponding to a UE-specific PUCCH resource corresponding to a minimum ID within an activated uplink BWP in a serving cell. In this case, the PUSCH transmission is based on a single antenna port. The UE does not expect to schedule the PUSCH transmission by the DCI format 0_0 within the BWP where no PUCCH resource including the pucch-spatialRelationInfo is configured. If the UE has not configured with the txConfig in the pusch-Config of Table 15, the UE does not expect to be scheduled by the DCI format 0_1.

TABLE 15

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS-UplinkConfig } |

OPTIONAL, -- Need M

| | |
|---|---|
| dmrs-UplinkForPUSCH-MappingTypeB | SetupRelease { DMRS-UplinkConfig } |

OPTIONAL, -- Need M

| | |
|---|---|
| pusch-PowerControl | PUSCH-PowerControl |

OPTIONAL, -- Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER (1.. |

maxNrofPhysicalResourceBlocks-1)

OPTIONAL, --

Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | |
|---|---|
| codebookSubset | ENUMERATED {fullyAndPartialAndNonCoherent, |

partialAndNonCoherent,nonCoherent}

OPTIONAL, -- Cond

codebookBased

| | | |
|---|---|---|
| maxRank | INTEGER (1..4) | OPTIONAL, -- |

Cond codebookBased

| | | |
|---|---|---|
| rbg-Size | ENUMERATED { config2} | OPTIONAL, |

-- Need S

| | | |
|---|---|---|
| uci-OnPUSCH | SetupRelease { UCI-OnPUSCH} | OPTIONAL, |

-- Need M

| | | |
|---|---|---|
| tp-pi2BPSK | ENUMERATED {enabled} | OPTIONAL, |

-- Need S
...

}

Next, the codebook-based PUSCH transmission will be described. The codebook-based PUSCH transmission may be dynamically scheduled by the DCI format 0_0 or 0_1, and operated semi-statically by the configured grant. When the codebook-based PUSCH may be dynamically scheduled by the DCI format 0_1, or configured semi-statically by the configured grant, the UE determines a precoder for the PUSCH transmission based on an SRS resource indicator (SRI), a transmission precoding matrix indicator (TPMI), and a transmission rank (the number of PUSCH transmission layers).

In this case, the SRI may be indicated by a field SRS resource indicator in the DCI or configured by srs-ResourceIndicator that is the higher layer signaling. When transmitting the codebook-based PUSCH, the UE may be configured with at least one SRS resource, and may be configured with up to two SRS resources. When the UE is provided with the SRI by the DCI, the SRS resource indicated by the corresponding SRI refers to an SRS resource corresponding to the SRI among the SRS resources transmitted before the PDCCH including the corresponding SRI. In addition, the TPMI and the transmission rank may be given through field precoding information and the number of layers in the DCI, or may be configured through precodingAndNumberOfLayers that is the higher layer signaling. The TPMI is used to indicate a precoder applied to the PUSCH transmission. When the UE is configured with one SRS resource, the TPMI is used to indicate the precoder to be applied in the one configured SRS resource. When the UE is configured with a plurality of SRS resources, the TPMI is used to indicate the precoder to be applied in the SRS resource indicated by the SRI.

The precoder to be used for the PUSCH transmission is selected from an uplink codebook having the same number of antenna ports as nrofSRS-Ports values in the SRS-Config that is the higher layer signaling. In the codebook-based PUSCH transmission, the UE determines a codebook subset based on the TPMI and the codebookSubset in the pusch-Config that is the higher layer signaling. The codebookSubset in the pusch-Config, which is the higher layer signaling, may be configured as one of ‘fullyAndPartialAndNonCoherent’, ‘partialAndNonCoherent’, or ‘nonCoherent’ based on the UE capability that the UE reports to the base station. When the UE reports the ‘partialAndNonCoherent’ as the UE capability, the UE does not expect the value of the codebookSubset, which is the higher layer signaling, to be configured as the ‘fullyAndPartialAndNonCoherent’. In addition, when the UE reports the ‘nonCoherent’ as the UE capability, the UE does not expect the value of the codebookSubset, which is the higher layer signaling, to be configured as the ‘fullyAndPartialAndNonCoherent’ or the ‘partialAndNonCoherent’. When the nrofSRS-Ports in SRS-ResourceSet, which is the higher layer signaling, indicates two SRS antenna ports, the UE does not expect the value of the codebookSubset, which is the higher layer signaling, to be configured as the ‘partialAndNonCoherent’.

The UE may be configured with one SRS resource set in which a usage value in the SRS-ResourceSet, which is the higher layer signaling, is configured as ‘codebook’, and indicated with one SRS resource within the corresponding SRS resource set by the SRI. If the plurality of SRS resources are configured in the SRS resource set in which the usage value in the SRS-ResourceSet, which is the higher layer signaling, is configured as the ‘codebook’, the UE expects the value of the nrofSRS-Ports in the SRS-Resource, which is the higher layer signaling, to be set to the same value for all the SRS resources.

The UE may transmit one or more SRS resources included in the SRS resource set in which the usage value is set to the ‘codebook’ according to the higher layer signaling to the base station, and the base station may select one of the SRS resources that the UE transmits and indicate for the UE to perform the PUSCH transmission using the transmission beam information of the corresponding SRS resource. In this case, in the codebook-based PUSCH transmission, the SRI is used as information for selecting an index of one SRS resource and is included in the DCI. Additionally, the base station includes the information indicating the TPMI and rank to be used by the UE for the PUSCH transmission in the DCI. The UE performs the PUSCH transmission by applying the precoder indicated by the indicated rank and TPMI based on the transmission beam of the corresponding SRS resource using the SRS resource indicated by the SRI.

Next, the non-codebook-based PUSCH transmission will be described. The non-codebook-based PUSCH transmission may be dynamically scheduled by the DCI format 0_0 or 0_1, and operated semi-statically by the configured grant. When at least one SRS resource is configured in the SRS resource set in which the usage value in the SRS-ResourceSet, which is the higher layer signaling, is configured as the ‘nonCodebook’, the UE may be scheduled with the non-codebook-based PUSCH transmission by the DCI format 0_1.

For the SRS resource set in which the usage value in the SRS-ResourceSet, which is the higher layer signaling, is configured as the ‘nonCodebook’, the UE may be configured with one connected NZP CSI-RS resource (non-zero power CSI-RS). The UE may perform a calculation of a precoder for SRS transmission by measuring the NZP CSI-RS resource connected to the SRS resource set. If a difference between a last received symbol of an aperiodic NZP CSI-RS resource connected to the SRS resource set and a first symbol of an aperiodic SRS transmission at the UE is less than 42 symbols, the UE does not expect information on the precoder for the SRS transmission to be updated.

If a value of resourceType in the SRS-ResourceSet, which is the higher layer signaling, is configured as ‘aperiodic’, the connected NZP CSI-RS is indicated by an SRS request that is a field in the DCI format 0_1 or 1_1. In this case, if the connected NZP CSI-RS resource is the aperiodic NZP CSI-RS resource, when the value of the field SRS request in the DCI format 0_1 or 1_1 is not ‘00’, it is indicated that there is the connected NZP CSI-RS. In this case, the corresponding DCI should not indicate a cross carrier or cross BWP scheduling. In addition, when a value of the SRS request indicates the existence of the NZP CSI-RS, the corresponding NZP CSI-RS is positioned in the slot in which the PDCCH including the SRS request field is transmitted. In this case, TCI states configured for the scheduled subcarrier are not configured as QCL-TypeD.

If a periodic or semi-persistent SRS resource set is configured, the connected NZP CSI-RS may be indicated by associatedCSI-RS in the SRS-ResourceSet that is the higher layer signaling. For the non-codebook-based transmission, the UE does not expect that the spatialRelationInfo, which is the higher layer signaling for the SRS resource, and the associatedCSI-RS in the SRS-ResourceSet, which is the higher layer signaling, are configured together.

When the plurality of SRS resources are configured, the UE may determine the precoder and transmission rank to be applied to the PUSCH transmission based on the SRI indicated by the base station. In this case, the SRI may be indicated by the field SRS resource indicator in the DCI or configured by the srs-ResourceIndicator that is the higher layer signaling. Similar to the above-described codebook-based PUSCH transmission, when the UE is provided with the SRI by the DCI, the SRS resource indicated by the corresponding SRI refers to the SRS resource corresponding to the SRI among the SRS resources transmitted before the PDCCH including the corresponding SRI. The UE may use one or more SRS resources for SRS transmission, and the maximum number of SRS resources that may be simultaneously transmitted in the same symbol within one SRS resource set is determined by the UE capability reported by the UE to the base station. In this case, the SRS resources that the UE simultaneously transmits occupy the same RB. The UE configures one SRS port for each SRS resource. Only one SRS resource set in which the usage value in the SRS-ResourceSet, which is the higher layer signaling, is configured as the ‘nonCodebook’ may be configured, and up to four SRS resources for the non-codebook-based PUSCH transmission may be configured.

The base station transmits one NZP-CSI-RS connected to the SRS resource set to the UE, and the UE calculates the precoder to be used when transmitting one or more SRS resources in the corresponding SRS resource set based on the result measured when receiving the corresponding NZP-CSI-RS. When the UE transmits one or more SRS resources in the SRS resource set in which the usage is configured as the ‘nonCodebook’ to the base station, the UE applies the calculated precoder, and the base station selects one or more SRS resources from the received one or more SRS resources. In this case, in the non-codebook based PUSCH transmission, the SRI represents an index that may express a combination of one or more SRS resources, and the SRI is included in the DCI. In this case, the number of SRS resources indicated by the SRI that the base station transmits may be the number of transmission layers of the PUSCH, and the UE transmits the PUSCH by applying the precoder applied to the SRS resource transmission in each layer.

### [CA/DC Related]

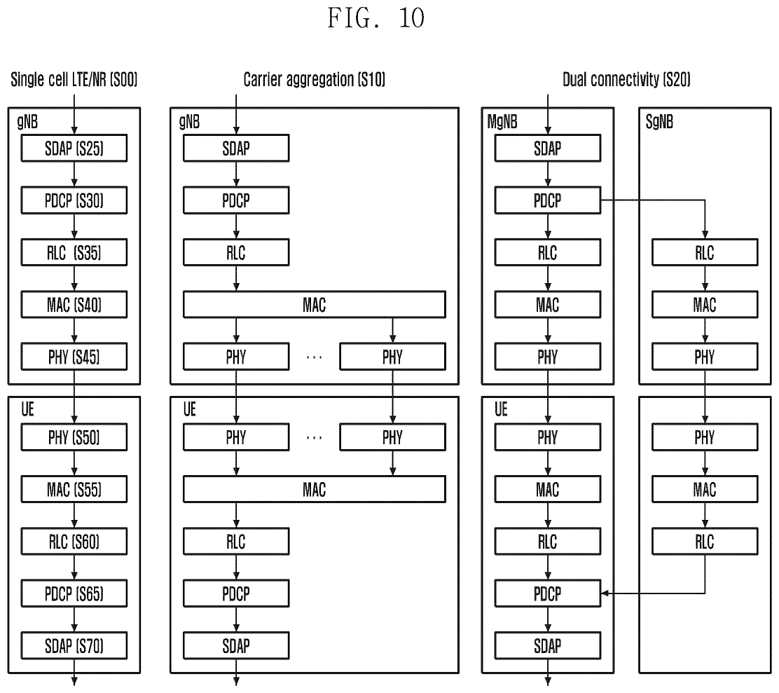

FIG. 10 is a diagram illustrating a wireless protocol structure of the base station and the UE in the single cell, the carrier aggregation, and the dual connectivity situation according to an embodiment of the disclosure.

Referring to FIG. 10, the wireless protocol of the next generation mobile communication system is composed of NR service data adaptation protocol (NR SDAP) S25 and S70, NR packet data convergence protocol (NR PDCP) S30 and S65, NR radio link control (NR RLC) (S35 and S60), and NR medium access control (NR MAC) S40 and S55 in the UE and the NR base station, respectively.

The main functions of the NR SDAP S25 and S70 may include some of the following functions.
User data transfer function (Transfer of user plane data)
Mapping function between quality of service (QoS) flow and data radio bearer (DRB) for both uplink and downlink (mapping between a QoS flow and a DRB for both DL and UL)
Marking function of QoS flow ID in both uplink and downlink (marking QoS flow ID in both DL and UL packets)
Function of mapping reflective QoS flow to data bearers for uplink SDAP protocol data units (PDUs) (reflective QoS flow to DRB mapping for the UL SDAP PDUs)

For an SDAP layer entity, the UE may be configured with whether to use a header of the SDAP layer entity or whether to use a function of the SDAP layer entity for each PDCP layer entity, each bearer, or each logical channel by an RRC message, and when the SDAP header is configured, the UE may indicate for a NAS QoS reflection configuration 1-bit indicator (NAS reflective QoS) and an AS QoS reflection configuration 1-bit indicator (AS reflective QoS) of the SDAP header to update or reset the mapping information for the QoS flow and data bearer of the uplink and downlink. The SDAP header may include QoS flow ID information indicating the QoS. The QoS information may be used as data processing priority, the scheduling information, etc., to support seamless services.

The main functions of the NR PDCP S30 and S60 may include some of the following functions.
Header compression and decompression function (Header compression and decompression: robust header compression (ROHC) only)
User data transfer function (Transfer of user data)
In-sequence delivery function (In-sequence delivery of upper layer PDUs)
Out-of-sequence delivery function (Out-of-sequence delivery of upper layer PDUs)
Reordering function (PDCP PDU reordering for reception)
Duplicate detection function (Duplicate detection of lower layer service data units (SDUs))
Retransmission function (Retransmission of PDCP SDUs)
Ciphering and deciphering function (Ciphering and deciphering)
Timer-based SDU discard function (Timer-based SDU discard in uplink)

The reordering function of the NR PDCP entity described above refers to the function of reordering PDCP PDUs received from a lower layer based on a PDCP sequence number (SN), and may include a function of delivering data to a higher layer in the reordered order. Alternatively, the reordering function of an NR PDCP entity may include a function of directly delivering data without considering the order, include a function of recording lost PDCP PDUs by reordering the PDCP PDUs, include a function of reporting a status of lost PDCP PDUs to a transmitting side, and include a function of requesting retransmission of the lost PDCP PDUs.

The main functions of the NR RLC S35 and S60 may include some of the following functions.
Data transfer function (Transfer of upper layer PDUs)
In-sequence delivery function (In-sequence delivery of upper layer PDUs)
Out-of-sequence delivery function (Out-of-sequence delivery of upper layer PDUs)
Automatic repeat request (ARQ) function (Error correction through ARQ)
Concatenation, segmentation, and reassembly function (Concatenation, segmentation and reassembly of RLC SDUs)
Re-segmentation function (Re-segmentation of RLC data PDUs)
Reordering function (Reordering of RLC data PDUs)
Duplicate detection function (Duplicate detection)
Error detection function (Protocol error detection)
RLC SDU discard function (RLC SDU discard)
RLC re-establishment function (RLC re-establishment)

The in-sequence delivery function of an NR RLC entity described above refers to a function of sequentially delivering the RLC SDUs received from the lower layer to the higher layer. When the original single RLC SDU is segmented into a plurality of RLC SDUs and received, the in-sequence delivery function of the NR RLC entity may include a function of reassembling and delivering these RLC SDUs, include a function of reordering the received RLC PDUs based on the RLC SN or PDCP SN, include a function of recording the lost RLC PDUs by the reordering, include a function of reporting the status of the lost RLC PDUs to the transmitting side, and include a function of requesting the retransmission of the lost RLC PDUs. The in-sequence delivery function of the NR RLC entity may include a function of delivering only the RLC SDUs up to the lost RLC SDU to the higher layer in order when there is the lost RLC SDU, or include a function of delivering all RLC SDUs received before a timer starts to the higher layer in sequence if the predetermined timer has expired even if there is the lost RLC SDU. Alternatively, the in-sequence delivery function of the NR RLC entity may include a function of delivering all the RLC SDUs received so far to the higher layer in order if the predetermined timer has expired even if there are the lost RLC SDUs. In addition, the RLC PDUs may be processed in the order that the RLC PDUs are received (in the order of arrival regardless of the order of the sequence number) and delivered to a PDCP entity regardless of the order (out-of sequence delivery), or, in case of segments, may be reconstructed into a single complete RLC PDU by receiving the segments stored in the buffer or to be received later, processed, and delivered to the PDCP entity. The NR RLC layer may not include the concatenation function, and perform the function in the NR MAC layer or be replaced by the multiplexing function of the NR MAC layer.

The out-of-sequence delivery function of the NR RLC entity described above refers to a function of directly delivering the RLC SDUs received from the lower layer to the higher layer regardless of the order. When the original single RLC SDU is segmented into the plurality of RLC SDUs and received, the in-sequence delivery function of the NR RLC entity may include a function of reassembling and delivering these RLC SDUs, and include a function of storing and ordering the RLC SN or the PDCP SN of the received RLC PDUs to record the lost RLC PDUs.

The NR MAC S40 and S55 may be connected to a plurality of NR RLC layer entities configured in one UE, and the main functions of NR MAC may include some of the following functions.
Mapping function (Mapping between logical channels and transport channels)
Multiplexing/demultiplexing function (Multiplexing/demultiplexing of MAC SDUs)
Scheduling information reporting function (Scheduling information reporting)
Hybrid ARQ (HARQ) function (Error correction through HARQ)
Priority handling function between logical channels (Priority handling between logical channels of one UE)
Priority handling function between UEs (Priority handling between UEs by means of dynamic scheduling)
Multimedia broadcast multicast service (MBMS) service identification function (MBMS service identification)
Transport format selection function (Transport format selection)
Padding function (Padding)

The NR PHY layer S45 and S50 may perform the operation of channel coding and modulating the higher layer data, converting the higher layer data into the OFDM symbols and transmitting the OFDM symbols through the wireless channel, or demodulating and channel decoding the OFDM symbols received through the wireless channel, and delivering the OFDM symbols to the higher layer.

The wireless protocol structure may have various detailed structures changing depending on a carrier (or cell) operation scheme. For example, when the base station transmits data to the UE based on a single carrier (or cell), the base station and the UE use a protocol structure having a single structure for each layer as in 800. On the other hand, when the base station transmits data to the UE based on carrier aggregation (CA) using multiple carriers in a single transmission and reception point (TRP), the base station and the UE use a protocol structure that has a single structure up to RLC as in S10, but multiplexes a PHY layer through a MAC layer. For another example, when the base station transmits data to the UE based on dual connectivity (DC) using multiple carriers in multiple TRPs, the base station and the UE use the protocol structure that has the single structure up to the RLC as in 820, but multiplexes the PHY layer through the MAC layer.

Referring to the descriptions related to the PDCCH and beam configuration described above, since PDCCH repetition transmission is not supported in the current Rel-15 and Rel-16 NR, it is difficult to achieve required reliability in scenarios requiring high reliability such as URLLC. The disclosure provides a PDCCH repetition transmission method through a plurality of transmission points (TRPs) to improve PDCCH reception reliability of a UE. The specific method is described in detail in the following embodiments.

Hereinafter, embodiments of the disclosure will be described in detail with the accompanying drawings. The contents of the disclosure can be applied to frequency division duplex (FDD) and TDD systems. In the disclosure below, the higher signaling (or the higher layer signaling) is a signal transmission method in which a base station transmits a signal to a UE using a downlink data channel of a physical layer, or a UE transmits a signal to a base station using an uplink data channel of the physical layer, and may also be referred to as RRC signaling, PDCP signaling, or a medium access control (MAC) control element (MAC control element (MAC CE)).

In the following disclosure, when determining whether cooperative communication is applied, the UE can use various methods, such as PDCCH(s) that allocate a PDSCH to which cooperative communication is applied having a specific format, PDCCH(s) that allocate a PDSCH to which cooperative communication is applied including a specific indicator indicating whether the cooperative communication is applied, PDCCH(s) that allocate a PDSCH to which cooperative communication is applied being scrambled by a specific RNTI, or assuming that cooperative communication is applied in a specific interval indicated by a higher layer. Hereinafter, for the convenience of description, the case where the UE receives the PDSCH to which the cooperative communication is applied based on conditions similar to the above description will be referred to as an NC-JT case.

Hereinafter, in the disclosure, determining a priority between A and B may be referred to in various ways, such as selecting one having a higher priority according to a predetermined priority rule to perform an operation corresponding to the selected priority, or omitting or dropping an operation for one having a lower priority.

Hereinafter, the disclosure will describe the above examples through a plurality of embodiments, but these embodiments are not independent and one or more embodiments may be applied simultaneously or in combination.

Hereinafter, embodiments of the disclosure will be described in detail with the accompanying drawings. Hereinafter, a base station is an entity that performs resource allocation of a terminal, and may be at least one of a gNode B, a gNB, an eNode B, a Node B, a base station (BS), a wireless access unit, a base station controller, or a node on a network. The terminal may include user equipment (UE), a mobile station (MS), a cellular phone, a smartphone, a computer, or a multimedia system capable of performing a communication function. Hereinafter, embodiments of the disclosure will be described using the 5G communication system as an example, but the embodiments of the disclosure may be applied to other communication systems having similar technical backgrounds or channel types. For example, LTE or LTE-A mobile communication and mobile communication technologies developed beyond the 5G may be included herein. In addition, the embodiments of the disclosure may be applied to other communication systems through some modifications without significantly departing from the scope of the disclosure as determined by a person having skilled technical knowledge. The contents of the disclosure can be applied to FDD and TDD systems.

In addition, in describing the disclosure, when it is determined that a detailed description for the related functions or configurations related to the disclosure may unnecessarily obscure the gist of the disclosure, the detailed description therefor will be omitted. Further, the following terminologies are defined in consideration of the functions in the disclosure and may be construed in different ways by the intention of users and operators, practice, etc. Therefore, the definitions thereof should be construed based on the contents throughout the specification.

Hereinafter, in describing the disclosure, the higher layer signaling may be signaling corresponding to at least one or a combination of one or more of the following signaling.
MIB (Master Information Block)
SIB (System Information Block) or SIB X (X=1, 2, . . . )
RRC (Radio Resource Control)
MAC (Medium Access Control) CE (Control Element)
In addition, the L1 signaling refers to signaling that may correspond to at least one or a combination of one or more signaling methods using the following physical layer channels or signaling.
PDCCH (Physical Downlink Control Channel)
DCI (Downlink Control Information)
UE-specific DCI
Group common DCI
Common DCI
Scheduling DCI (e.g., DCI used for the purpose of scheduling downlink or uplink data)
Non-scheduling DCI (e.g., DCI not used for the purpose of scheduling downlink or uplink data)
PUCCH (Physical Uplink Control Channel)
UCI (Uplink Control Information)

Hereinafter, in the disclosure, determining a priority between A and B may be referred to in various ways, such as selecting one having a higher priority according to a predetermined priority rule to perform an operation corresponding to the selected one, or omitting or dropping an operation for one having a lower priority.

Hereinafter, the disclosure will describe the above examples through a plurality of embodiments, but these embodiments are not independent and one or more embodiments may be applied simultaneously or in combination.

### [Random Access Procedure in SBFD]

Meanwhile, in the 3GPP, subband non-overlapping full duplex (SBFD) has been introduced as a new duplex method based on NR. The SBFD is a technology that utilizes some of downlink resources as uplink resources in a TDD band (spectrum) with a frequency of 6 GHz or less or a frequency of 6 GHz or more. The SBFD receives uplink transmission from a UE as much as the increased uplink resources, thereby expanding the uplink coverage of the UE, and receives feedback on downlink transmission from the UE in the extended uplink resources, thereby reducing feedback delay. In the disclosure, the UE that may receive information on whether the SBFD is supported from the base station and perform the uplink transmission in some of downlink resources may be referred to as an SBFD UE (SBFD-capable UE) for convenience. To define the SBFD scheme in the specifications and allow the SBFD UE to determine whether the SBFD is supported in a specific cell (or frequency, frequency band), the following scheme may be considered.

According to an embodiment, as a first scheme, to define the SFFD in addition to the existing unpaired spectrum (or time division duplex (TDD)) or paired spectrum (or frequency division duplex (FDD)) frame structure type, another frame structure type (e.g., frame structure type 2) may be introduced. The frame structure type 2 may be defined to be supported in a specific frequency or a frequency band, or the base station may indicate to the UE whether the SBFD is supported through the system information. The SBFD UE may receive the system information including whether to support the SBFD from the base station to determine whether the SBFD is supported in the specific cell (or frequency, frequency band).

In a second scheme according to an embodiment, it may be indicated whether the SBFD is additionally supported in the specific frequency or frequency band of the existing unpaired spectrum (or TDD) without defining a new frame structure type. In the second scheme, it may be defined whether the SBFD is additionally supported in the specific frequency or frequency band of the existing unpaired spectrum, or the base station may indicate to the UE whether the SBFD is supported through the system information. The SBFD UE may receive the system information including whether to support the SBFD from the base station to determine whether the SBFD is supported in the specific cell (or frequency, frequency band).

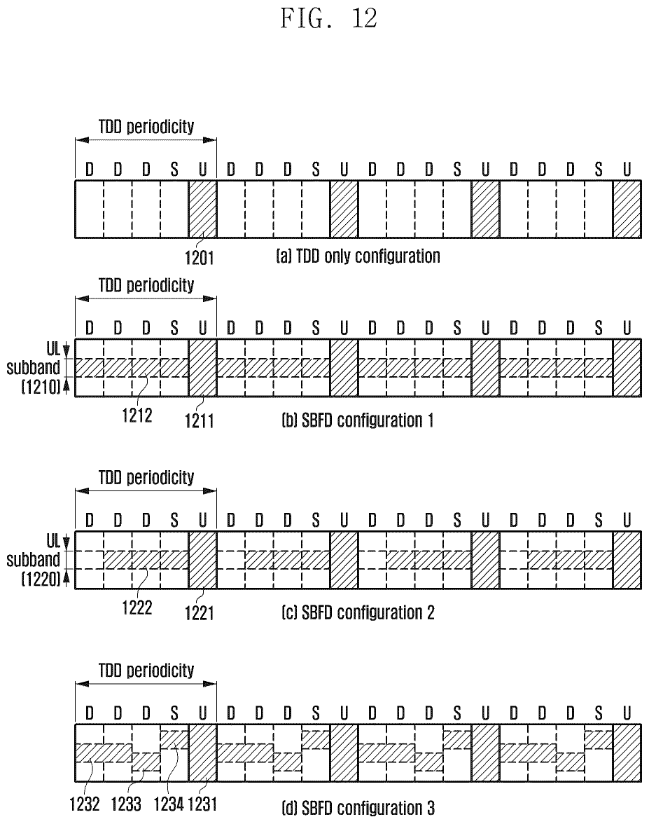

In the first and second schemes described above, the information on whether the SBFD is supported may be information (e.g., SBFD resource configuration information in FIG. 12 described below) that indirectly indicates whether the SBFD is supported by additionally configuring some of the downlink resources as the uplink resources in addition to configuring TDD uplink (UL)-downlink (DL) resource configuration information indicating a downlink slot (or symbol) resources and uplink slot (or symbol) resources of the TDD, or may be information that directly indicates whether the SBFD is supported.

In the disclosure, the SBFD UE may receive a synchronization signal block (SSB) in an initial cell access for accessing a cell (or base station) to acquire cell synchronization. The process of acquiring the cell synchronization may be the same for the SBFD UE and the existing TDD UE. Thereafter, the SBFD UE may determine whether the cell supports the SBFD through the MIB acquisition, the SIB acquisition, or a random access process.

The system information for transmitting the information on whether the SBFD is supported may be system information that is distinguished and transmitted separately from the system information for a UE (e.g., the existing TDD UE) supporting a different version of specifications within a cell, and the SBFD UE may acquire all or part of the system information transmitted separately from the system information for the existing TDD UE to determine whether the SBFD is supported. When the SBFD UE acquires only the system information for the existing TDD UE or acquires the system information indicating that the SBFD is not supported, the SBFD UE may determine that the cell (or base station) supports only the TDD.

When the information on whether the SBFD is supported is included in the system information for the UE (e.g., the existing TDD UE) supporting a different version of specifications, the information on whether the SBFD is supported may be inserted at the very end so as not to affect the acquisition of the system information by the existing TDD UE. When the SBFD UE does not acquire the information on whether the SBFD is supported that is inserted at the very end or acquires the information indicating that the SBFD is not supported, the SBFD UE may determine that the cell (or base station) supports only the TDD.

When the information on whether the SBFD is supported is included in the system information for the UE (e.g., the existing TDD UE) supporting a different version of specifications, the information on whether the SBFD is supported may be transmitted through the PDSCH so as not to affect the acquisition of the system information by the existing TDD UE. That is, the UE that does not support the SBFD may receive a first SIB (or SIB1) including the existing TDD-related system information through a first PDSCH. The UE that supports the SBFD may receive the first SIB (or SIB) including the existing TDD-related system information through the first PDSCH, and a second SIB including the SBFD-related system information through the second PDSCH. Here, the first PDSCH and the second PDSCH may be scheduled by a first PDCCH and a second PDCCH, and cyclic redundancy codes (CRCs) of the first PDCCH and the second PDCCH may be scrambled by the same RNTI (e.g., the SI-RNTI). The search space for monitoring the second PDCCH may be acquired from the system information of the first PDSCH, and if the search space is not acquired (i.e., if the system information of the first PDSCH does not include the information on the search space), the second PDCCH may be received in the same search space as the search space of the first PDCCH.

As described above, when the SBFD UE determines that the cell (or base station) supports only the TDD, the SBFD UE may perform the random access procedure and transmit and receive the data/control signals in the same manner as the existing TDD UE.

The base station may configure separate random access resources for each of the existing TDD UE or the SBFD UE (e.g., SBFD UE supporting duplex communication and SBFD UE supporting half-duplex communication), and transmit configuration information (control information or configuration information indicating a time-frequency resource that may be used for the PRACH) for the random access resources to the SBFD UE through the system information. The system information for transmitting the information on the random access resources may be system information that is distinguished and transmitted separately from the system information for the UE (e.g., the existing TDD UE) supporting a different version of specifications within the cell.

The base station may configure the random access resource for the TDD UE, and additionally configure separate random access resource for the SBFD UE. Here, the SBFD UE may use the random access resource for the TDD UE, and the SBFD UE may not use the random access resource for the TDD UE. In the latter case, the SBFD UE may always use only a separate random access resource for the SBFD UE.

The SBFD UE may be indicated by the base station whether the SBFD UE may use the random access resource for the TDD UE. The random access resource may be indicated by being included in the SIB. That is, in the SIB, the separate random access resources for the SBFD UE may be configured, and along with the configuration, it may be indicated whether the random access resource for the TDD UE may be used. The random access resource may be indicated by 1 bit. If the 1 bit is ‘0’ (or FALSE), the SBFD UE may be indicated to be unable to use the random access resource for the TDD UE. If the 1 bit is ‘1’ (or TRUE), the SBFD UE may be indicated to be able to use the random access resource for the TDD UE.

The base station may determine a type of UE attempting to access the cell based on the random access resource used by the UE. For example, the SBFD UE may transmit the PRACH through the separate random access resource for the SBFD UE, and the base station may determine that the SBFD UE is attempting to access the cell when receiving the PRACH. For example, the TDD UE may transmit the PRACH through the random access resource for the TDD UE, and the base station may determine that the TDD UE is attempting to access the cell when receiving the PRACH. For reference, when the SBFD UE is allowed to transmit the PRACH through the random access resource of the TDD UE, the base station may determine that it is ambiguous whether the type of the UE transmitting the PRACH is the TDD UE or the SBFD UE. In this case, the base station may assume that the type of the UE is always the TDD UE.

When the base station determines that the UE is the SBFD UE, the base station may schedule Msg2, Msg3, Msg4, etc., for the UE based on the uplink subband configuration upon scheduling the Msg2, Msg3, Msg4, etc. That is, when the base station schedules the reception of the Msg2 and Msg4 for the UE, the Msg2 and Msg4 may be scheduled not to be received in the uplink subband (when the UE receives the PDSCH including the Msg2 and Msg4, the PDSCH is received in a frequency resource other than the uplink subband). When the base station schedules an Msg3 PUSCH for the UE, the Msg3 PUSCH may be scheduled to be transmitted within the uplink subband.

When the base station determines that the UE is the TDD UE, the base station may not use the uplink subband configuration upon scheduling the Msg2, Msg3, Msg4. That is, even if the uplink subband is configured in a downlink symbol or a flexible symbol, the base station may assume that the UE may not acquire the uplink subband configuration information. When the base station schedules the Msg3 PUSCH for the UE, the Msg3 PUSCH may be scheduled in the flexible symbol or the uplink symbol. In other words, when the base station determines that the UE is the TDD UE, the Msg3 PUSCH may not be scheduled in the uplink subband.

Alternatively, the base station may not configure a separate random access resource for the SBFD UE, but may configure a common random access resource to all UEs in the cell. In this case, the configuration information of the random access resource may be transmitted to all the UEs in the cell through the system information, and the SBFD UE that has received the system information may perform random access on the random access resource. Thereafter, the SBFD UE may complete the random access process and proceed to an RRC connected mode for transmitting and receiving data to and from the cell. After the RRC connected mode, the SBFD UE may receive, from the base station, a higher or physical signal that may determine that some frequency resources of the downlink time resources are configured as the uplink resources, and may perform the SBFD operation, for example, transmit the uplink signal in the uplink resources.

When the SBFD UE determines that the cell supports the SBFD, it may notify the base station that the UE that is attempting to access is the SBFD UE by transmitting to the base station capability information including at least one of whether the UE supports the SBFD, whether the UE supports the full-duplex or half-duplex communication, and the number of transmit or receive antennas the UE has (or supports). Alternatively, in case the half-duplex communication support is an essential implementation for the SBFD UE, whether the half-duplex communication is supported may be omitted from the capability information. The SBFD UE's report on the capability information may be reported to the base station through the random access process, may be reported to the base station after completing the random access process, or may be reported to the base station after proceeding to the RRC connected mode for transmitting and receiving data to and from the cell.

The SBFD UE may support the half-duplex communication that performs only the uplink transmission or downlink reception in a moment like the existing TDD UE, or support the full-duplex communication that performs both the uplink transmission and downlink reception in a moment. Accordingly, the SBFD UE may report whether the half-duplex communication or the full-duplex communication is supported to the base station through the capability report, and after the report, the base station may configure for the SBFD UE whether the SBFD UE transmits and receives data using the half-duplex communication or the full-duplex communication. When the SBFD UE reports the capability for the half-duplex communication to the base station, since there is generally no duplexer, the SBFD UE may require a switching gap to change radio frequency (RF) between transmission and reception when operating in the FDD or TDD.

In general, the UE may form a radio link with a network through the random access procedure based on the synchronization with the network and the system information acquired during a cell search process of a cell. The random access may use a contention-based or contention-free scheme. The contention-based random access scheme may be used when the UE performs cell selection and reselection during the initial access stage of the cell, for example, when moving from an RRC_IDLE state to an RRC_CONNECTED state. The contention-free random access scheme may be used to re-establish uplink synchronization when the downlink data arrives, in case of a handover, or in case of position measurement.

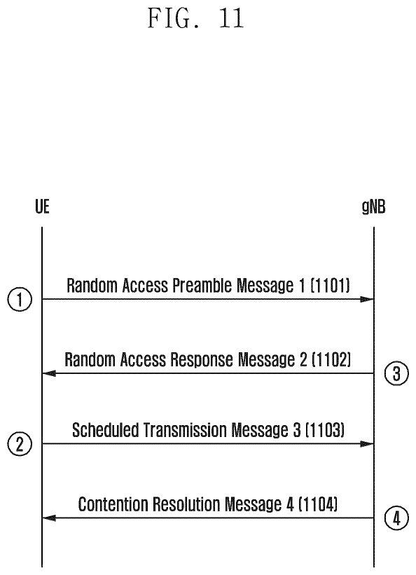

FIG. 11 is a diagram illustrating the random access procedure in the wireless communication system according to an embodiment of the disclosure.

Referring to FIG. 11, the contention-based random access procedure is illustrated as an example. In addition, although not illustrated, the base station may transmit a synchronization signal block as described in the above-described embodiments. In this case, the base station may periodically transmit the synchronization signal block using beam sweeping. For example, the base station may transmit a synchronization signal block including a PSS/SSS (synchronization signal) and a broadcast channel (PBCH) signal using up to 64 different beams for 5 ms, and transmit a plurality of synchronization signal blocks using different beams. The UE may detect (select) a synchronization signal block having an optimal beam direction (e.g., a beam direction in which the received signal strength is the strongest or greater than a predetermined threshold) and transmit a preamble using a physical random access channel (PRACH) resource associated with the detected synchronization signal block. For example, as a first step 1101 of the random access procedure, the UE may transmit a random access preamble (or message 1, Msg1) to the base station. The base station receiving the random access preamble may measure a transmission delay value between the UE and the base station and adjust the uplink synchronization.

Specifically, the UE may transmit a random access preamble randomly selected within a random access preamble set previously given by the system information. The initial transmit power of the random access preamble may be determined according to a pathloss measured by the UE between the base station and the UE. In addition, the UE may determine a transmission beam direction (or transmission beam or beam) of the random access preamble based on the synchronization signal block received from the base station and transmit the random access preamble by applying the determined transmission beam direction.

In a second step 1102, the base station may transmit a response (the random access response, RAR, or message 2 (Msg2)) to the detected random access attempt to the UE. The base station may transmit an uplink transmission timing control command to the UE based on the transmission delay value measured from the random access preamble received in the first step. In addition, the base station may transmit an uplink resource and a power control command to be used by the UE as the scheduling information. The scheduling information may include control information for an uplink transmission beam of the UE. The RAR is transmitted through the PDSCH and may include at least one of the following information.
Random access preamble sequence index detected by the network (or base station)
TC-RNTI (temporary cell radio network temporary identifier)
Uplink scheduling grant
Timing advance value

If the UE does not receive the RAR, which is the scheduling information for message 3, from the base station for a predetermined time in the second step 1102, the first step 1101 may be performed again. When the first step is performed again, the UE may increase transmit power (e.g., power ramping) of the random access preamble by a predetermined step and transmit the random access preamble, thereby increasing the probability that the base station receives the random access preamble.

In a third step 1103, the UE may transmit uplink information (scheduled transmission, message 3, etc.) including its UE identity (e.g., UE contention resolution identity)(or, valid UE identity if the UE already has valid UE identity (C-RNTI) within the cell before the random access procedure starts) to the base station through the uplink data channel (physical uplink shared channel (PUSCH)) using the uplink resource allocated in the second step 1102. The PUSCH may be referred to as message 3 PUSCH (Msg3 PUSCH). The transmission timing of the uplink data channel for transmitting the message 3 may follow the uplink transmission timing control command received from the base station in the second step 1102. In addition, the transmit power of the uplink data channel for transmitting the message 3 may be determined in consideration of the power control command received from the base station in the second step 1102 and a power ramping value of the random access preamble. The uplink data channel for transmitting the message 3 may be an initial uplink data signal that the UE transmits to the base station after the UE transmits the random access preamble.

Finally, in a fourth step 1104, if the base station determines that the UE has performed the random access without collision with another UE, the base station may transmit to the corresponding UE a message (contention resolution message (CR message), or message 4) including the UE identity that has transmitted the uplink data in the third step 1103.

In this regard, when a plurality of UEs receive the same TC-RNTI in the second step 1102, the plurality of UEs receiving the same TC-RNTI may each transmit the message 3 including their own UE identities (UE contention resolution identity) to the base station in the third step 1103, and the base station may transmit message 4 (CR message) including one of a plurality of UE identities for contention resolution. When the UE receives message 4 (CR message) including its own UE identity from the base station in the fourth step 1104 (or when transmitting the message 3 including the UE identity (the C-RNTI) in the third step 1103 and receiving UE-specific control information including the CRC based on the UE identity (C-RNTI) through the PDCCH in the fourth step 1104), the UE may determine that the random access is successful. Therefore, among the plurality of UEs that have received the same TC-RNTI from the base station, a UE that has identified that its UE identity is included in the message 4 (CR message) may identify that the contention has been successful. Then, the UE may transmit HARQ-ACK/NACK indicating whether the message 4 has been successfully received to the base station through the uplink control channel (physical uplink control channel (PUCCH)).

If the data transmitted by the UE in the third step 1103 and data of another UE collide with each other and the base station fails to receive the data signal from the UE, the base station may no more perform data transmission to the UE. Accordingly, if the UE fails to receive the data transmitted from the base station in the fourth step 1104 for a certain time interval, it may be determined that the random access procedure has failed and may be restarted from the first step 1101.

As described above, in the first step 1101 of the random access process, the UE may transmit the random access preamble on the PRACH. Each cell has 64 available preamble sequences, and four long preamble formats and nine short preamble formats may be used depending on the transmission format. The UE may generate 64 preamble sequences using a root sequence index and a cyclic shift value signaled as the system information, and may randomly select one sequence to be used as a preamble.

The base station may notify the UE of the configuration information of the random access resource, for example, the control information (or configuration information) indicating a time-frequency resource that may be used for the PRACH, using at least one of the SIB, the higher layer signaling (radio resource control (RRC) information), or downlink control information (DCI). The frequency resource for the PRACH transmission may indicate a starting RB point of transmission to the UE, and the number of RBs used may be determined depending on the preamble format transmitted through the PRACH and the applied subcarrier spacing. The time resource for the PRACH transmission may be notified through PRACH configuration indexes 0 to 255, such as a predetermined PRACH configuration periodicity, a subframe index and start symbol including a PRACH occasion (which may be used interchangeably with an occasion), and the number of PRACH occasions in a slot, as illustrated in Table 16 below. The UE may determine the validity of the PRACH occasions indicated by the PRACH configuration index, and determine only the valid PRACH occasions as the PRACH occasions that may transmit the random access preamble. Through the PRACH configuration index, the random access configuration information included in the SIB, and the index of the SSB selected by the UE, the UE may identify the time and frequency resources to transmit the random access preamble, and transmit the selected sequence as a preamble to the base station.

TABLE 16

| | | | | | | | number of | |
|---|---|---|---|---|---|---|---|---|
| | | | | | | | time-domain | |
| | | | | | | Number of | PRACH | |
| PRACH | | | | | | PRACH slots | occasions | |
| configuration | Preamble | | | Subframe | Starting | within a | within a | PRACH |
| index | format | n_{SRS} | | number | symbol | subframe | PRACH slot | duration |
| 0 | 0 | 16 | 1 | 1 | 0 | — | — | 0 |
| 1 | 0 | 16 | 1 | 4 | 0 | — | — | 0 |
| 2 | 0 | 16 | 1 | 7 | 0 | — | — | 0 |
| 3 | 0 | 16 | 1 | 9 | 0 | — | — | 0 |
| 4 | 0 | 8 | 1 | 1 | 0 | — | — | 0 |
| 5 | 0 | 8 | 1 | 4 | 0 | — | — | 0 |
| 6 | 0 | 8 | 1 | 7 | 0 | — | — | 0 |
| 7 | 0 | 8 | 1 | 9 | 0 | — | — | 0 |
| 8 | 0 | 4 | 1 | 1 | 0 | — | — | 0 |
| 9 | 0 | 4 | 1 | 4 | 0 | — | — | 0 |
| 10 | 0 | 4 | 1 | 7 | 0 | — | — | 0 |
| . . . | . . . | | | | | | | |
| 104 | A1 | 1 | 0 | 1, 4, 7 | 0 | 2 | 6 | 2 |
| . . . | . . . | | | | | | | |
| 251 | C | 1 | 0 | 2, 7 | 0 | 2 | 2 | 6 |
| 252 | C2 | 1 | 0 | 1, 4, 7 | 0 | 2 | 2 | 6 |
| 253 | C2 | 1 | 0 | 0, 2, 4, 6, 8 | 0 | 2 | 2 | 6 |
| 254 | C2 | 1 | 0 | 0, 1, 2, 3, 4, | 0 | 2 | 2 | 6 |
| | | | | 5, 6, 7, 8, 9 | | | | |
| 255 | C2 | 1 | 0 | 1, 3, 5, 7, 9 | 0 | 2 | 2 | 6 |

According to an embodiment of the disclosure, when the SBFD UE determines the validity of the PRACH occasion through the PRACH configuration index and the SBFD configuration for performing the PRACH transmission and performs the PRACH transmission through the PRACH occasion determined to be valid, the procedure of the SBFD UE may be required when the valid PRACH occasion and the downlink reception overlap with each other.

Therefore, the method for an SBFD UE to determine validity of a PRACH occasion and the operation of the SBFD UE when the valid PRACH occasion and the downlink reception are configured or scheduled to occur simultaneously will be described with reference to FIGS. 8, 9, and 10.

FIG. 12 is a diagram illustrating an example in which the SBFD operates in the TDD spectrum of the wireless communication system according to an embodiment of the disclosure.

Referring to part (a) of FIG. 12, the case where the TDD operates in a specific frequency band is illustrated. In the cell operating the TDD, the base station may transmit and receive signals including data/control information in a downlink slot (or symbol), an uplink slot (or symbol) 1201, and a flexible slot (or symbol) based on a configuration of TDD UL-DL resource configuration information indicating a downlink slot (or symbol) resource and an uplink slot (or symbol) resource of the existing TDD UE or the SBFD UE and the TDD.

In FIG. 12, it may be assumed that a DDDSU slot format is configured according to the TDD UL-DL resource configuration information. Here, ‘D’ is a slot composed entirely of downlink symbols, ‘U’ is a slot composed entirely of uplink symbols, and ‘S’ is a slot that is not ‘D’ or ‘U,’ that is, a slot that includes the downlink symbol or the uplink symbol or includes the flexible symbol. Here, for convenience, it may be assumed that S is composed of 12 downlink symbols and 2 flexible symbols. The DDDSU slot format may be repeated according to the TDD UL-DL resource configuration information. Referring to FIG. 12, a repetition periodicity of the TDD configuration may be exemplified as 5 slots (5 ms for 15 kHz SCS, 2.5 ms for 30 kHz SCS, etc.).

Next, in parts (b), (c), and (d) of FIG. 12, the case where the SBFD operates together with the TDD in a specific frequency band is illustrated.

Referring to part (b) of FIG. 12, the UE may be configured with some of frequency bands of a cell as a frequency band 1210 in which the uplink transmission is possible. This band may be called an uplink subband (UL subband). The UL subband may be applied to all symbols of all slots. The UE may transmit an uplink channel or signal scheduled in all symbols 1212 within the subband (UL subband). However, the UE may not transmit the uplink channel or signal in a band other than the subband (UL subband) and an uplink slot 1211.

Referring to part (c) of FIG. 12, the UE may be configured with some of the frequency bands of the cell as a frequency band 1220 in which the uplink transmission is possible, and may be configured with a time domain in which the frequency band is activated. Here, the frequency band may be called the uplink subband (UL subband). In part (c) of FIG. 12, the UL subband is deactivated in a first slot, and the UL subband may be activated in the remaining slots. Therefore, the UE may transmit the uplink channel or signal in a UL subband 1222 of the remaining slot (including uplink slot 1221).

According to an embodiment, the UL subband is activated on a slot-by-slot basis, but may be configured to be activated on a symbol-by-symbol basis.

Referring to part (d) of FIG. 12, the UE may be configured with the time-frequency resource for which the uplink transmission is possible in association with the UL subband. The UE may be configured with one or more time-frequency resources as time-frequency resources for which the uplink transmission is possible. For example, a part of a frequency band 1232 of the first slot and the second slot may be configured with the time-frequency resource for which the uplink transmission is possible. In addition, a part of a frequency band 1233 of a third slot and a part of a frequency band 1234 of a fourth slot may be configured with the time-frequency resource for which the uplink transmission is possible. In addition, UE may transmit the uplink channel or signal in an uplink slot 1231.

According to an embodiment, the frequency resources for the uplink subband may be configured to be the same or different on a slot-by-slot basis, but may also be configured on a symbol-by-symbol basis. In addition, the time domain that is activated may be combined and configured by considering the time resource.

In the following description, the time-frequency resource for which the uplink transmission is possible in the downlink symbol or the flexible symbol may be called the SBFD resource, the uplink subband, or the UL subband.

### [PUSCH Repetition on SBFD UL Subband]

The UE may receive the scheduling information of the Msg3 PUSCH from the base station. The scheduling information of the Msg3 PUSCH may be included in a RAR UL grant.

The RAR UL grant may include at least one of the following information, but is not limited to the examples below:
Frequency hopping flag—1 bit
PUSCH frequency resource allocation—14 bits
PUSCH time resource allocation—4 bits
MCS—4 bits
TPC command for PUSCH—3 bits
CSI request—1 bit

The UE may acquire time domain scheduling information (scheduled slot and symbol within the slot) of the Msg3 PUSCH through a PUSCH time resource allocation field. For example, the PUSCH time resource allocation field is 4 bits and may indicate one of the 16 rows of a table. The field (table) may include a slot offset, a starting symbol index within a slot, the number of consecutive symbols, a PUSCH mapping type, etc.

The UE may transmit the Msg3 PUSCH in the symbols of the slot indicated in the time domain scheduling information. In this case, the UE may not transmit the Msg3 PUSCH repeatedly. For example, the UE may transmit the Msg3 PUSCH only once in the symbols of the indicated slot.

The UE may additionally request the repetition transmission of the Msg3 PUSCH from the base station for uplink coverage expansion. The UE may indicate or include the request by transmitting a specific PRACH to the base station. Here, the specific PRACH may correspond to a specific RACH occasion, a specific preamble (e.g., a preamble corresponding to a specific index), etc. When the UE requests the Msg3 PUSCH repetition transmission, the PUSCH transmission of the UE may be as follows.

According to an embodiment, the UE may acquire a 4-bit modulation coding scheme (MCS) field from the RAR UL grant. Most significant bit (MSB) 2 bits of the 4-bit MCS field may indicate the PUSCH repetition transmission count. LSB 2 bits of the MCS field may indicate an MCS value of the PUSCH.

According to an embodiment, when there is no separate configuration, the MSB 2 bits may be interpreted as one value of {R1, R2, R3, R4} as the Msg3 PUSCH repetition count. The UE may be configured with R1, R2, R3, and R4 values by the base station. In this case, the UE may apply the values configured by the base station. For example, when the MSB 2 bits are ‘00’, the Msg3 PUSCH repetition count may be R1, if the MSB 2 bits are ‘01’, the Msg3 PUSCH repetition count may be R2, if the MSB 2 bits are ‘10’, the Msg3 PUSCH repetition count may be R3, and if the MSB 2 bits are ‘11’, the Msg3 PUSCH repetition count may be R4. According to an embodiment, the case where the repetition count is 1 may be the same as transmitting without repetition.

According to an embodiment, the Msg3 PUSCH may be retransmitted in the DCI format 0_0. For example, the DCI format 00 may include a 5-bit MCS field, and the UE may be indicated with the Msg3 PUSCH repetition count using MSB 2 bits among 5 bits.

According to an embodiment, when the UE is indicated to perform the R repetition transmission, the UE may repeatedly transmit the Msg3 PUSCH as follows. The UE may determine R slots (including a slot in which a first Msg3 PUSCH is transmitted) starting from a slot in which the first Msg3 PUSCH is transmitted. Here, when any one slot includes symbols scheduled for the Msg3 PUSCH that are neither symbols configured as downlink according to the cell-common TDD configuration nor symbols overlapping with the SS/PBCH blocks, the slot may be included in the R slots.

According to an embodiment, the SBFD UE may receive the SBFD configuration in addition to the cell-common TDD configuration. Here, the SBFD configuration may be the cell-common configuration. For example, the cell-common configuration may indicate a configuration that is equally applied to all UEs accessing the cell (cell-specific). According to an embodiment, the cell-common configuration may be transmitted through the system information block (SIB). According to the SBFD configuration, an SBFD UL subband may be configured for the downlink symbol or the flexible symbol configured in the cell-common TDD configuration. In the SBFD UL subband, the UE may transmit the uplink channel or signal.

According to an embodiment, a non-SBFD symbol may refer to a symbol in which the SBFD subband is not configured according to the SBFD configuration. In addition, a DL-only symbol or a UL-only symbol may indicate a DL symbol and an UL symbol among the non-SBFD symbols. The SBFD symbol may be a symbol in which the SBFD subband is configured according to the SBFD configuration. According to an embodiment, the SBFD configuration may be configured for the DL symbol and the flexible symbol, and may not be configured for the UL symbol (or, may not be applied to the UL symbol even if configured).

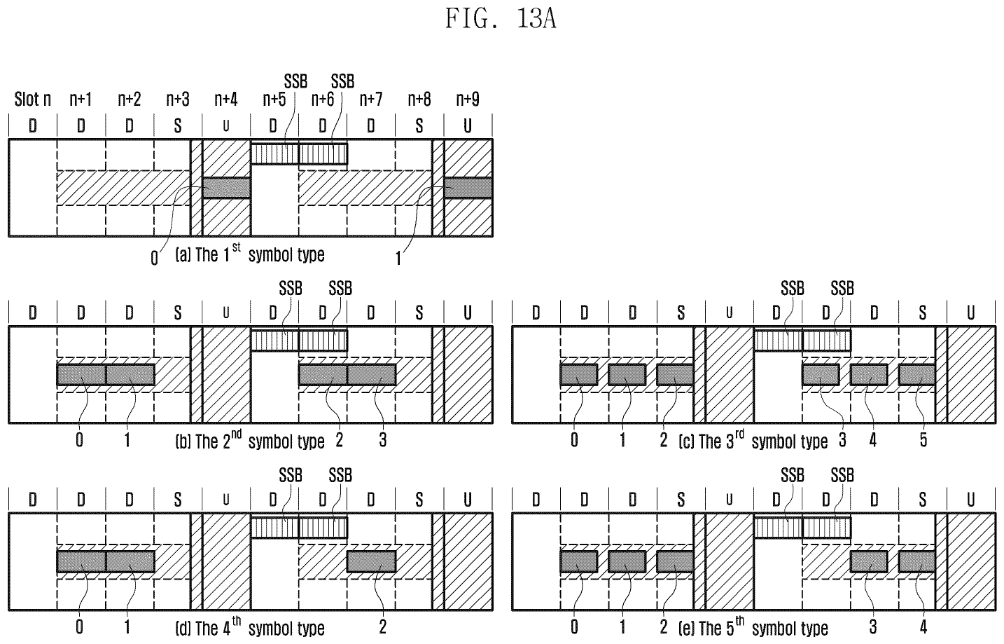

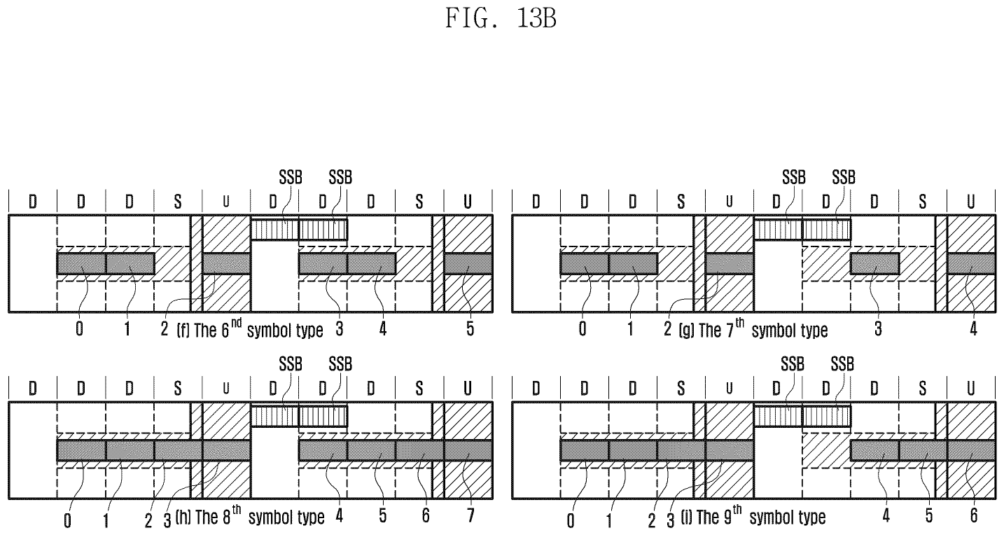

FIGS. 13A and 13B are diagrams illustrating specific symbol types for determining a slot in which the Msg3 PUSCH is repeatedly transmitted according to various embodiments of the disclosure.

Referring to FIGS. 13A and 13B, the cell-common TDD configuration received by the UE may be DDDSU. Here, ‘D’ indicates that all 14 symbols in a slot (D slot) represent downlink, ‘U’ indicates that all 14 symbols in a slot (U slot) represent uplink, and ‘S’ indicates 14 symbols in a slot (S slot) in which 10 symbols are downlink symbols, 2 symbols are flexible symbols, and 2 symbols are uplink symbols in order. In the remaining drawings except for parts (c) and (e) of FIG. 13A, the Msg3 PUSCH may include all symbols (i.e., 14 symbols) in the slot. In parts (c) and (e) of FIG. 13A, the Msg3 PUSCH may include the first 12 symbols in the slot. The SS/PBCH block (SSB) may be configured in slot n+5 and slot n+6. In FIGS. 13A and 13B, the SBFD UL subband may be configured from a first symbol of the second D slot to a 12th symbol of the S slot.

According to an embodiment, the SBFD UL subband may be configured in the downlink symbol (10 symbols) and the flexible symbol (2 symbols) in the S slot, but the SBFD UL subband may not be configured in the uplink symbol (2 symbols).

According to an embodiment, the SBFD UE may consider at least following options to determine a slot in which the Msg3 PUSCH is repeatedly transmitted.

The SBFD UE may be configured with a type of symbols, in which the Msg3 PUSCH may be repeatedly transmitted, by the base station. The SBFD UE may be configured by the base station to repeatedly transmit the Msg3 PUSCH only in a specific symbol type.

According to an embodiment, a first specific symbol type may be a symbol configured as downlink according to the cell-common TDD configuration or a symbol excluding the symbols overlapping with the SS/PBCH block. That is, the SBFD UE may determine the same symbol as the symbol in which the existing UE may repeatedly transmit the Msg3 PUSCH as a specific type. In addition, the SBFD UE may be configured with the SBFD UL subband for the downlink symbol, but may not repeatedly transmit the Msg3 PUSCH in the SBFD UL subband.

When the SBFD UE is indicated to perform the R repetition transmission, the SBFD UE may repeatedly transmit the Msg3 PUSCH as follows. The SBFD UE may determine the R slots (including the slot in which the first Msg3 PUSCH is transmitted) starting from the slot in which the first Msg3 PUSCH is transmitted. Here, when any one slot includes the symbols scheduled for the Msg3 PUSCH that are neither the symbols configured as the downlink according to the cell-common TDD configuration nor the symbols overlapping with the SS/PBCH block, the slot may be included in the R slots.

Referring to part (a) of FIG. 13A, since the Msg3 PUSCH overlaps with the downlink symbols in slots n, n+1, n+2, n+3, n+5, n+6, n+7, and n+8, the UE does not transmit the Msg3 PUSCH and may repeatedly transmit the Msg3 PUSCH in slots n+4 and n+9.

According to an embodiment, a second specific symbol type may be the downlink symbols in which the SBFD UL subband is configured. For example, the Msg3 PUSCH may be repeatedly transmitted only in the SBFD UL subband within the downlink symbol. The Msg3 PUSCH may not be repeatedly transmitted in the downlink symbol, the flexible symbol, and the uplink symbol in which the SBFD UL subband is not configured.

When the SBFD UE is indicated to perform the R repetition transmission, the SBFD UE may repeatedly transmit the Msg3 PUSCH as follows. The SBFD UE may determine the R slots (including the slot in which the first Msg3 PUSCH is transmitted) starting from the slot in which the first Msg3 PUSCH is transmitted. For example, when any one slot includes only symbols scheduled for the Msg3 PUSCH that are the downlink symbols according to the cell-common TDD configuration, and symbols configured for the SBFD UL subband according to the SBFD configuration, the slot may be included in the R slots.

According to an embodiment, the frequency domain allocation information of the Msg3 PUSCH received by the UE may be scheduled within a frequency width of the SBFD UL subband.

Referring to part (b) of FIG. 13A, since the Msg3 PUSCH overlaps with the downlink symbols in which the SBFD UL subband is configured in slots n+1, n+2, n+6, and n+7, the UE may transmit the Msg3 PUSCH, and since the Msg3 PUSCH overlaps with the flexible symbols or the uplink symbols in slots n+3, n+4, n+8, and n+9, the UE may not transmit the Msg3 PUSCH in the slots. Since the Msg3 PUSCH overlaps with the downlink symbols in which the SBFD UL subband is not configured in slots n and n+5, the UE may not transmit the Msg3 PUSCH in the slots.

According to an embodiment, a third specific symbol type may be the symbols in which the SBFD UL subband is configured. For example, the Msg3 PUSCH may be repeatedly transmitted only within the SBFD UL subband. The Msg3 PUSCH may not be repeatedly transmitted in the symbol in which the SBFD UL subband is not configured.

When the SBFD UE is indicated to perform the R repetition transmission, the SBFD UE may repeatedly transmit the Msg3 PUSCH as follows. The SBFD UE may determine the R slots (including the slot in which the first Msg3 PUSCH is transmitted) starting from the slot in which the first Msg3 PUSCH is transmitted. For example, when any one slot includes only symbols scheduled for the Msg3 PUSCH comprising symbols configured for the SBFD UL sub-bands according to the SBFD configuration, the slot may be included in the R slots.

According to an embodiment, the frequency domain allocation information of the Msg3 PUSCH received by the UE may be scheduled within the frequency width of the SBFD UL subband.

Referring to part (c) of FIG. 13A, since the Msg3 PUSCH overlaps with the symbols in which the SBFD UL subband is configured in slots n+1, n+2, n+3, n+6, n+7, and n+8, the UE may transmit the Msg3 PUSCH, and since the Msg3 PUSCH overlaps with the symbols in which the SBFD UL subband is not configured in slots n, n+4, n+5, and n+9, the UE may not transmit the Msg3 PUSCH in the slots.

According to an embodiment, a fourth specific symbol type may be the downlink symbol in which the SBFD UL subband not overlapping with the SS/PBCH block is configured. For example, the Msg3 PUSCH may be repeatedly transmitted only within the SBFD UL subband in the downlink symbol that does not overlap with the SS/PBCH block. In addition, the Msg3 PUSCH may not be repeatedly transmitted in the downlink symbols in which the SBFD UL subband is not configured, the downlink symbols in which the SBFD UL subband is configured but which overlaps with the SS/PBCH block, the flexible symbols, and the uplink symbols.

When the SBFD UE is indicated to perform the R repetition transmission, the SBFD UE may repeatedly transmit the Msg3 PUSCH as follows. The SBFD UE may determine the R slots (including the slot in which the first Msg3 PUSCH is transmitted) starting from the slot in which the first Msg3 PUSCH is transmitted. For example, when any one slot includes only symbols scheduled for the Msg3 PUSCH that are the downlink symbols according to the cell-common TDD configuration, and symbols that are not the SS/PBCH block among the symbols configured for the SBFD UL subband according to the SBFD configuration, the slot may be included in the R slots.

According to an embodiment, the frequency domain allocation information of the Msg3 PUSCH received by the UE may be scheduled within the frequency width of the SBFD UL subband.

Referring to part (d) of FIG. 13A, since the Msg3 PUSCH overlaps with the downlink symbols in which the SBFD UL subband is configured in slots n+1, n+2, and n+7, without overlapping with the SS/PBCH block, the UE may transmit the Msg3 PUSCH. Since the Msg3 PUSCH overlaps with the SS/PBCH block in slot n+6, the UE may not transmit the Msg3 PUSCH. Since the flexible symbols or the uplink symbols overlap with the Msg3 PUSCH in slots n+3, n+4, n+8, and n+9, the UE may not transmit the Msg3 PUSCH in the slots. Since the Msg3 PUSCH overlaps with the downlink symbols in which the SBFD UL subband is not configured in slots n and n+5, the UE may not transmit the Msg3 PUSCH in the slots.

According to an embodiment, a fifth specific symbol type may be the symbol in which the SBFD UL subband not overlapping with the SS/PBCH block is configured. For example, the Msg3 PUSCH may be repeatedly transmitted only within the SBFD UL subband in the symbol that does not overlap with the SS/PBCH block. The Msg3 PUSCH may not be repeatedly transmitted in the symbol in which the SBFD UL subband is not configured and the symbol overlapping with the SS/PBCH block.

When the SBFD UE is indicated to perform the R repetition transmission, the SBFD UE may repeatedly transmit the Msg3 PUSCH as follows. The SBFD UE may determine the R slots (including the slot in which the first Msg3 PUSCH is transmitted) starting from the slot in which the first Msg3 PUSCH is transmitted. For example, when any one slot does not include only symbols scheduled for the Msg3 PUSCH that overlap with the SS/PBCH block and symbols configured for the SBFD UL subband according to the SBFD configuration, the slot may be included in the R slots.

According to an embodiment, the frequency domain allocation information of the Msg3 PUSCH received by the UE may be scheduled within the frequency width of the SBFD UL subband.

Referring to part (e) of FIG. 13A, since the Msg3 PUSCH overlaps with the symbols in which the SBFD UL subband is configured in slots n+1, n+2, n+3, n+7, and n+8, without overlapping with the SS/PBCH block, the UE may transmit the Msg3 PUSCH. Since the Msg3 PUSCH overlaps with the SS/PBCH block in slot S+6, the UE may not transmit the Msg3 PUSCH. Since the Msg3 PUSCH overlaps with symbols in which the SBFD UL subband is not configured in slots n, n+4, n+5, and n+9, the UE may not transmit the Msg3 PUSCH in the slots.

According to an embodiment, a sixth specific symbol type may be the symbols in which the SBFD UL subband is configured, and the flexible symbols and the uplink symbols configured according to the cell-common TDD. For example, in the sixth specific symbol type, the Msg3 PUSCH may be repeatedly transmitted across the SBFD symbol and the non-SBFD symbol. In the sixth specific symbol type, each Msg3 PUSCH repetition may overlap with only one type of symbol. For example, in the SBFD symbol, the Msg3 PUSCH should be included in the SBFD UL subband, and in the non-SBFD symbol, the Msg3 PUSCH should be included in the UL BWP.

When the SBFD UE is indicated to perform the R repetition transmission, the SBFD UE may repeatedly transmit the Msg3 PUSCH as follows. The SBFD UE may determine the R slots (including the slot in which the first Msg3 PUSCH is transmitted) starting from the slot in which the first Msg3 PUSCH is transmitted. For example, when any one slot includes symbols scheduled for the Msg3 PUSCH that satisfy the following conditions, the slot may be included in the R slots according to an embodiment.
The Msg3 PUSCH includes only one symbol type among the SBFD symbol and the non-SBFD symbol,
When the Msg3 PUSCH includes only the SBFD symbol, the frequency band occupied by the Msg3 PUSCH should be entirely included in the SBFD UL subband,
When the Msg3 PUSCH includes only the non-SBFD symbol, the frequency band occupied by the Msg3 PUSCH should be entirely included in the UL BWP.

Referring to part (f) of FIG. 13B, since the Msg3 PUSCH overlaps with the symbols in which the SBFD UL subband is configured or the uplink symbols in slots n+1, n+2, n+4, n+6, n+7, and n+9, the UE may transmit the Msg3 PUSCH (i.e., it may be considered that the conditions listed above are satisfied). Since one Msg3 PUSCH repetition overlaps with two symbol types in slots n+3 and n+8, the UE may not transmit the Msg3 PUSCH in the slots. Since the Msg3 PUSCH overlaps with the downlink symbol in slots n and n+5, the UE may not transmit the Msg3 PUSCH in the slots.

According to an embodiment, a seventh specific symbol type may be the symbols in which the SBFD UL subband is configured among the symbols that do not overlap with the SS/PBCH block, and the flexible symbol and the uplink symbol configured according to the cell-common TDD. For example, in the seventh specific symbol type, the Msg3 PUSCH may be repeatedly transmitted across the SBFD symbol and the non-SBFD symbol among the symbols that do not overlap with the SS/PBCH block. In the seventh specific symbol type, each Msg3 PUSCH repetition may overlap with only one type of symbol. For example, in the SBFD symbol, the Msg3 PUSCH should be included in the SBFD UL subband, and in the non-SBFD symbol, the Msg3 PUSCH should be included in the UL BWP.

When the SBFD UE is indicated to perform the R repetition transmission, the SBFD UE may repeatedly transmit the Msg3 PUSCH as follows. The SBFD UE may determine the R slots (including the slot in which the first Msg3 PUSCH is transmitted) starting from the slot in which the first Msg3 PUSCH is transmitted. For example, when any one slot includes symbols scheduled for the Msg3 PUSCH that satisfy the following conditions, the slot may be included in the R slots according to an embodiment.
The Msg3 PUSCH includes only the symbol that does not overlap with the SS/PBCH block,
The Msg3 PUSCH includes only one symbol type among the SBFD symbol and the non-SBFD symbol,
When the Msg3 PUSCH includes only the SBFD symbol, the frequency band occupied by the Msg3 PUSCH should be entirely included in the SBFD UL subband,
When the Msg3 PUSCH includes only the non-SBFD symbol, the frequency band occupied by the Msg3 PUSCH should be entirely included in the UL BWP.

Referring to part (g) of FIG. 13B, since the Msg3 PUSCH overlaps with the symbols in which the SBFD UL subband is configured or the uplink symbols in slots n+1, n+2, n+4, n+7, and n+9, without overlapping with the SS/PBCH block, the UE may transmit the Msg3 PUSCH (i.e., it may be considered that the conditions listed above are satisfied). Since the Msg3 PUSCH overlaps with the SS/PBCH block in slot n+6, the UE may not transmit the Msg3 PUSCH. Since one Msg3 PUSCH repetition overlaps with two symbol types in slots n+3 and n+8, the UE may not transmit the Msg3 PUSCH in the slots. Since the Msg3 PUSCH overlaps with the downlink symbol in slots n and n+5, the UE may not transmit the Msg3 PUSCH in the slots.

According to an embodiment, an eighth specific symbol type may be the symbols in which the SBFD UL subband is configured and the flexible symbols and the uplink symbols configured according to the cell-common TDD. For example, in the eighth specific symbol type, the Msg3 PUSCH may be repeatedly transmitted across the SBFD symbol and the non-SBFD symbol. In the eighth specific symbol type, one Msg3 PUSCH may include two symbol types. For example, in the SBFD symbol, the Msg3 PUSCH should be included in the SBFD UL subband, and in the non-SBFD symbol, the Msg3 PUSCH should be included in the UL BWP.

When the SBFD UE is indicated to perform the R repetition transmission, the SBFD UE may repeatedly transmit the Msg3 PUSCH as follows. The SBFD UE may determine the R slots (including the slot in which the first Msg3 PUSCH is transmitted) starting from the slot in which the first Msg3 PUSCH is transmitted. For example, when any one slot includes symbols scheduled for the Msg3 PUSCH that satisfy the following conditions, the slot may be included in the R slots according to an embodiment.
When the Msg3 PUSCH includes the SBFD symbol, the frequency band occupied by the Msg3 PUSCH should be entirely included in the SBFD UL subband,
When the Msg3 PUSCH includes only the non-SBFD symbol, the frequency band occupied by the Msg3 PUSCH should be entirely included in the UL BWP.

Referring to part (h) of FIG. 13B, since the Msg3 PUSCH overlaps with the symbols in which the SBFD UL subband is configured or the flexible symbols and the uplink symbols in slots n+1, n+2, n+3, n+4, n+6, n+7, n+8 and n+9, the UE may transmit the Msg3 PUSCH (i.e., it may be considered that the conditions listed above are satisfied). Since the Msg3 PUSCH overlaps the downlink symbol in slots n and n+5, the UE may not transmit the Msg3 PUSCH in the slots.

According to an embodiment, a ninth specific symbol type may be the symbols in which the SBFD UL subband is configured among the symbols that do not overlap with the SS/PBCH block, and the flexible symbols and the uplink symbols configured according to the cell-common TDD. For example, in the ninth specific symbol type, the Msg3 PUSCH may be repeatedly transmitted across the SBFD symbol and the non-SBFD symbol among the symbols that do not overlap with the SS/PBCH block. In the ninth specific symbol type, one Msg3 PUSCH may include two symbol types.

For example, in the SBFD symbol, the Msg3 PUSCH should be included in the SBFD UL subband, and in the non-SBFD symbol, the Msg3 PUSCH should be included in the UL BWP.

When the SBFD UE is indicated to perform the R repetition transmission, the SBFD UE may repeatedly transmit the Msg3 PUSCH as follows. The SBFD UE may determine the R slots (including the slot in which the first Msg3 PUSCH is transmitted) starting from the slot in which the first Msg3 PUSCH is transmitted. For example, when any one slot includes symbols scheduled for the Msg3 PUSCH that satisfy the following conditions, the slot may be included in the R slots according to an embodiment.
The Msg3 PUSCH includes only the symbol that does not overlap with the SS/PBCH block,
When the Msg3 PUSCH includes the SBFD symbol, the frequency band occupied by the Msg3 PUSCH should be entirely included in the SBFD UL subband,
When the Msg3 PUSCH includes only the non-SBFD symbol, the frequency band occupied by the Msg3 PUSCH should be entirely included in the UL BWP.

Referring to part (i) of FIG. 13B, since the Msg3 PUSCH overlaps with the symbols in which the SBFD UL subband is configured or the flexible symbols and the uplink symbols in slots n+1, n+2, n+3, n+4, n+7, n+8, and n+9, the UE may transmit the Msg3 PUSCH (i.e., it may be considered that the conditions listed above are satisfied). Since the Msg3 PUSCH overlaps with the SS/PBCH block in slot n+6, the UE may not transmit the Msg3 PUSCH. Since the Msg3 PUSCH overlaps with the downlink symbol in slots n and n+5, the UE may not transmit the Msg3 PUSCH in the slots.

The UE may be indicated with at least one of the first specific symbol type to the ninth specific symbol type by the base station. The indication may be transmitted by being included in the system information block (SIB) transmitted by the base station. According to an embodiment, the indication may be included in SIB1.

According to an embodiment, the UE may receive at least one of the following indications from the base station, and may determine symbols on which the Msg3 PUSCH may be transmitted based on the indications.
Whether the Msg3 PUSCH transmission is possible in the SBFD UL subband. For example, the information may be indicated by 1 bit. When the Msg3 PUSCH transmission is possible in the SBFD UL subband, the Msg3 PUSCH may be transmitted in at least one of the second specific symbol type, the third specific symbol type, the fourth specific symbol type, the fifth specific symbol type, the sixth specific symbol type, the seventh specific symbol type, the eighth specific symbol type, and the ninth specific symbol type. When the Msg3 PUSCH transmission is not possible in the SBFD UL subband, the Msg3 PUSCH may be transmitted in the first specific symbol type.
Whether the Msg3 PUSCH transmission is possible in the symbol overlapping with the SS/PBCH block. For example, the information may be indicated by 1 bit. When the Msg3 PUSCH transmission is possible in the symbol overlapping with the SS/PBCH block, the Msg3 PUSCH may be transmitted in at least one of the first specific symbol type, the second specific symbol type, the third specific symbol type, the sixth specific symbol type, and the eighth specific symbol type.
Whether the Msg3 PUSCH transmission is possible across the SBFD symbol and the non-SBFD symbol. For example, the information may be indicated by 1 bit. When the Msg3 PUSCH may be transmitted across the SBFD symbol and the non-SBFD symbol, the Msg3 PUSCH may be transmitted in at least one of the sixth specific symbol type, the seventh specific symbol type, the eighth specific symbol type, and the ninth specific symbol type. When the Msg3 PUSCH transmission is not possible in the SBFD UL subband, the Msg3 PUSCH may be transmitted in the first specific symbol type. When the transmission of the Msg3 PUSCH is not possible across the SBFD symbol and the non-SBFD symbol, the Msg3 PUSCH may be transmitted in at least one of the second specific symbol type, the third specific symbol type, the fourth specific symbol type, and the fifth specific symbol type.
Whether one Msg3 PUSCH repetition transmission is possible across the SBFD symbol and the non-SBFD symbol. This information may be additionally indicated when possibility is indicated in terms of whether the Msg3 PUSCH transmission is possible across the SBFD symbol and the non-SBFD symbol. For example, the information may be indicated by 1 bit. When one Msg3 PUSCH repetition is capable of transmitting the Msg3 PUSCH across the SBFD symbol and the non-SBFD symbol, the Msg3 PUSCH may be transmitted in at least one of the eighth specific symbol type and the ninth specific symbol type. When one Msg3 PUSCH repetition is incapable of transmitting the Msg3 PUSCH across the SBFD symbol and the non-SBFD symbol, the Msg3 PUSCH may be transmitted in at least one of the sixth specific symbol type and the seventh specific symbol type.

Table 17 may represent symbol types determined by the UE according to the indication received from the base station. Table 17 and the first specific symbol type to the ninth specific symbol type are examples, and the base station may not transmit all indications to the UE, and some specific symbols may not be indicated.

The specific symbol type determined according to an embodiment of the disclosure may be applied to not only the Msg3 PUSCH transmission but also the PUCCH transmitting HARQ-ACK of the Msg4 PDSCH or the PUSCH transmitted by RRC connected UE.

In the disclosure, it is described that the base station configures the specific symbol type for the UE, but one specific symbol type may be defined as the standard document specification. For example, the Msg3 PUSCH transmission may always be possible only in the first specific symbol type.

TABLE 17

| | | | Whether one | |
|---|---|---|---|---|
| | Whether | Whether | Msg3 PUSCH | |
| | Msg3 PUSCH | Msg3 PUSCH | repetition | |
| Whether | transmission | transmission | transmission | |
| Msg3 PUSCH | is possible | is possible | is possible | |
| transmission | in symbol | across SBFD | across SBFD | |
| is possible | overlapping | symbol and | symbol and | |
| in SBFD UL | with SS/PBCH | non-SBFD | non-SBFD | Determined |
| subband | block | symbol | symbol | symbol type |
| Impossibility | — | — | — | First specific |
| | | | | symbol type |
| Possibility | Impossibility | Impossibility | — | Fourth specific |
| | | | | symbol type or |
| | | | | fifth specific |
| | | | | symbol type |
| Possibility | Impossibility | Possibility | Impossibility | Seventh specific |
| | | | | symbol type |
| Possibility | Impossibility | Possibility | Possibility | Ninth specific |
| | | | | symbol type |
| Possibility | Possibility | Impossibility | — | Second specific |
| | | | | symbol type, |
| | | | | third specific |
| | | | | symbol type |
| Possibility | Possibility | Possibility | Impossibility | Sixth specific |
| | | | | symbol type |
| Possibility | Possibility | Possibility | Possibility | Eighth specific |
| | | | | symbol type |

According to an embodiment of the disclosure, the UE may acquire the indication through the RAR UL grant. For example, the UE may acquire the repetition count of the Msg3 PUSCH from the MSB 2 bits of the MCS field of the RAR UL grant by the base station. The UE may additionally acquire the indication from the MSB 2 bits. When the base station configures the repetition count {R1, R2, R3, R4} corresponding to the MSB 2 bits, the base station may configure the specific symbol type to be used together with the repetition count value. For example, R2=4 may be set and the first specific symbol type may be configured. In this case, if the MSB 2 bits of the MCS field of the RAR UL grant are ‘01’, the UE may repeat the Msg3 PUS CH 4 times, and the symbol type that may be used for the repetition transmission may be the first specific symbol type. The UE may be configured with different symbol types at different 2-bit MSB codepoints {R1, R2, R3, R4} by the base station. Therefore, the UE may acquire the information on the Msg3 PUSCH repetition count and the transmittable symbol type from the 2-bit MSB. In case of the PUCCH transmitting the HARQ-ACK of the Msg4 PDSCH, the PUCCH may be transmitted in the same symbol type as the Msg3 PUSCH.

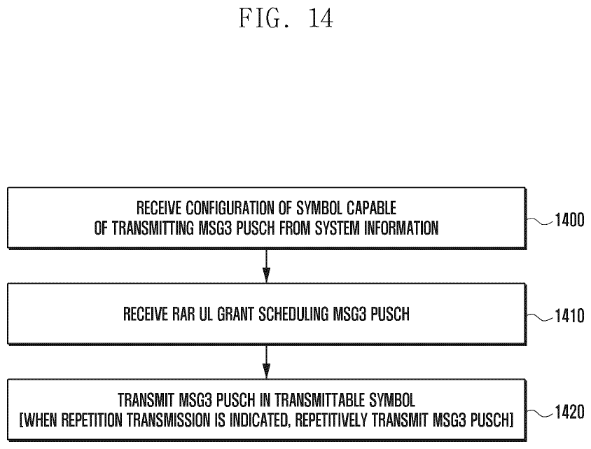

FIG. 14 is a diagram illustrating a sequence diagram for transmitting the Msg3 PUSCH of the UE according to an embodiment of the disclosure.

In operation 1400, the UE may receive the configuration that includes the information on the symbols capable of transmitting the Msg3 PUSCH from the system information transmitted by the base station. According to an embodiment, the UE may determine symbols that may be used for the transmission of the Msg3 PUSCH from the information. The information may include the indications according to an embodiment of the disclosure.

In operation 1410, the UE may receive the RAR UL grant for scheduling the Msg3 PUSCH. The UE may acquire the symbols in which the Msg3 PUSCH is scheduled or the Msg3 PUSCH repetition count from the PAR UL grant.

In operation 1420, the UE may determine the transmittable slots in order to repeatedly transmit the Msg3 PUSCH according to the repetition count. According to an embodiment, the transmittable slots may be determined based on the information acquired in operation 1400. For example, the UE may transmit the Msg3 PUSCH in the symbols that may be used for the transmission of the Msg3 PUSCH in operation 1400, and may not transmit the Msg3 PUSCH in the symbols that may not be used for the transmission of the Msg3 PUSCH.

### [PUSCH Frequency Hopping Bit Determination]

The UE may acquire the scheduling information of the Msg3 PUSCH from the RAR UL grant. According to an embodiment, the UE may be indicated whether to perform the frequency hopping for the Msg3 PUSCH through a frequency hopping flag field, and may acquire the frequency domain allocation information of the Msg3 PUSCH through the PUSCH frequency resource allocation field.

According to an embodiment, the MSB 1 bit or MSB 2 bits of the PUSCH frequency resource allocation field may be used to indicate a frequency hopping offset value.

Referring to Table 18, the UE may determine the number of bits indicating a frequency hopping offset value based on the size of the initial UL BWP. According to an embodiment, if the number N of RBs included in the initial UL BWP is less than a certain number, the number of bits indicating the frequency hopping offset value may be 1, and if the number B_{BWP}^{size} of RBs included in the initial UL BWP is greater than or equal to a certain number N_{BWP}^{size} the number of bits indicating the frequency hopping offset value may be 2. For example, the certain number may be 50 RBs.

According to an embodiment, when the number of bits indicating the frequency hopping offset value is 1, if the MSB 1 bit of the PUSCH frequency resource allocation field is ‘0’, the frequency hopping offset value may be └N_{BWP}^{size}/2┘, and if the MSB 1 bit is ‘1’, the frequency hopping offset value may be └N_{BWP}^{size}/4┘.

According to an embodiment, when the number of bits indicating the frequency hopping offset value is 2, if the MSB 2 bits of the PUSCH frequency resource allocation field are ‘00’, the frequency hopping offset value may be └N_{BWP}^{size}/2┘, if the MSB 2 bits are ‘01’, the frequency hopping offset value may be └N_{BWP}^{size}/4┘, and if the MSB 2 bits are ‘10’, the frequency hopping offset value may be −└N_{BWP}^{size}/4┘. In addition, if the MSB 2 bits are ‘11’, the frequency hopping offset value may not be defined. For example, ‘11’ may be an unused code point.

TABLE 18

| Number of PRBs in | Value of N_{ULhop} | Frequency offset for 2^{nd} |
|---|---|---|
| initial UL BWP | Hopping Bits | hop in non-SBFD symbol |
| N_{BWP}^{size} < 50 | 0 | └N_{BWP}^{size}/2┘ |
| | 1 | └N_{BWP}^{size}/4┘ |
| N_{BWP}^{size} ≥ 50 | 00 | └N_{BWP}^{size}/2┘ |
| | 01 | └N_{BWP}^{size}/4┘ |
| | 10 | −└N_{BWP}^{size}/4┘ |
| | 11 | Reserved |

The SBFD UE may acquire the Msg3 PUSCH scheduling information in the SBFD UL subband from the RAR UL grant. In this case, the frequency hopping offset value of the UE may be determined as follows. According to an embodiment, the SBFD UL subband may be defined as the SBFD UL subband included in the initial UL BWP.

According to Table 19, if the number N_{ULSB} of RBs included in the SBFD UL subband is less than a certain number, the number of bits indicating the frequency hopping offset value by the SBFD UE may be 1, and if the number N_{ULSB} of RBs included in the initial UL BWP is greater than or equal to a certain number, the number of bits indicating the frequency hopping offset value by the SBFD UE may be 2. For example, the certain number may be 50 RBs.

According to an embodiment, when the number of bits indicating the frequency hopping offset value is 1, if the MSB 1 bit of the PUSCH frequency resource allocation field is ‘0’, the frequency hopping offset value may be └N_{ULSB}/2┘, and if the MSB 1 bit is ‘1’, the frequency hopping offset value may be └N_{ULSB}/4┘.

According to an embodiment, when the number of bits indicating the frequency hopping offset value is 2, if the MSB 2 bits of the PUSCH frequency resource allocation field are ‘00’, the frequency hopping offset value may be └N_{ULSB}/2┘, if the MSB 2 bits are ‘01’, the frequency hopping offset value may be └N_{ULSB}/4┘, and if the MSB 2 bits are ‘10’, the frequency hopping offset value may be −└N_{ULSB}/4┘. For reference, if the MSB 2 bits are ‘11’, the frequency hopping offset value may not be defined. For example, ‘11’ may be the unused code point.

TABLE 19

| Number of PRBs | Value of N_{ULhop} | Frequency offset for |
|---|---|---|
| in UL subband | Hopping Bits | 2^{nd} hop in SBFD symbol |
| N_{ULSB} < [50] | 0 | └N_{ULSB}/2┘ |
| | 1 | └N_{ULSB}/4┘ |
| N_{ULSB} ≥ [50] | 00 | └N_{ULSB}/2┘ |
| | 01 | └N_{ULSB}/4┘ |
| | 10 | −└N_{ULSB}/4┘ |
| | 11 | Reserved |

In the disclosure, Table 19 is used for description, but the disclosure may also be applied to other frequency hopping offset value determination methods.

According to an embodiment, the Msg3 PUSCH may be repeatedly transmitted in the SBFD symbol and the non-SBFD symbol. According to an embodiment, the Msg3 PUSCH transmitted in the SBFD symbol may be called the SBFD Msg3 PUSCH, and the Msg3 PUSCH transmitted in the non-SBFD symbol may be called a non-SBFD Msg3 PUSCH or a legacy Msg3 PUSCH, and is not limited to the above expressions.

A problem to be solved in the disclosure may correspond to a method for determining whether to perform the frequency hopping in each the SBFD symbol and the non-SBFD symbol when the UE transmits the Msg3 PUSCH.

According to an embodiment, the UE may acquire a frequency hopping flag 1 bit from the RAR UL grant. The UE may commonly apply the frequency hopping flag to both the SBFD Msg3 PUSCH and the non-SBFD Msg3 PUSCH. For example, if the value of the frequency hopping flag is ‘0’, both the SBFD Msg3 PUSCH and the non-SBFD Msg3 PUSCH may not use the frequency hopping. If the value of the frequency hopping flag is ‘1’, both the SBFD Msg3 PUSCH and the non-SBFD Msg3 PUSCH may use the frequency hopping.

According to an embodiment, the frequency band in which the non-SBFD Msg3 PUSCH may be transmitted (determined by the initial UL BWP) may be larger than the frequency band in which the SBFD Msg3 PUSCH may be transmitted (determined by the SBFD UL subband). According to an embodiment, since the non-SBFD Msg3 PUSCH and the SBFD Msg3 PUSCH may be simultaneously indicated with the frequency hopping, unnecessary frequency hopping for the SBFD Msg3 PUSCH may be indicated.

According to an embodiment, the UE may acquire the frequency hopping flag 1 bit from the RAR UL grant. The UE may apply the frequency hopping flag only to the non-SBFD Msg3 PUSCH. Whether the SBFD Msg3 PUSCH is hopped may be determined as follows.

In a first method, the SBFD Msg3 PUSCH may not always perform the frequency hopping. For example, the bandwidth of the SBFD UL subband may generally not be large, and a frequency diversity gain that may be acquired by the frequency hopping may be small in the bandwidth. Therefore, the SBFD Msg3 PUSCH transmitted in the SBFD UL subband may not always perform the frequency hopping.

In a second method, whether the frequency hopping for the SBFD Msg3 PUSCH is performed may be configured by the base station. For example, the configuration may be included in the system information block (SIB) that transmits the system information, and may be commonly applied to all UEs in the cell. Depending on the configuration, the UE may determine whether to transmit the SBFD Msg3 PUSCH with the frequency hopping applied or without the frequency hopping applied.

In a third method, it may be determined whether the frequency hopping for the SBFD Msg3 PUSCH is performed based on the bandwidth of the SBFD UL subband. For example, when the number of RBs included in the SBFD UL subband is less than a certain number, the UE does not perform frequency hopping, and when the number of RBs included in the SBFD UL subband is greater than or equal to a certain number, the UE may always perform the frequency hopping.

The fourth method may determine whether to perform the SBFD Msg3 PUSCH frequency hopping based on the number of RBs scheduled for the Msg3 PUSCH. For example, when the number of RBs scheduled for the Msg3 PUSCH is less than a certain number, the UE may perform the frequency hopping, and when the number of RBs scheduled for the Msg3 PUSCH is greater than a certain number, the UE may not perform the frequency hopping.

The fifth method may indicate the SBFD Msg3 PUSCH frequency hopping through some fields of the RAR UL grant. For example, the MSB 2 bits of the MCS field of the RAR UL grant may indicate the Msg3 PUSCH repetition transmission count. For example, the MSB 2 bits may indicate one of the {R1, R2, R3, R4} values. The base station may configure whether to perform the frequency hopping for the UE along with each repetition count value. For example, when the MSB 2 bits are ‘01’, R2 is indicated by the Msg3 PUSCH repetition count, and whether the frequency hopping is possible may be indicated along with the repetition count value. In the MCS field, for example, the UE may be indicated with whether to perform the SBFD Msg3 PUSCH frequency hopping through other fields of the RAR UL grant.

According to an embodiment, the second to fifth methods may be used only when the frequency hopping flag 1 bit of the RAR UL grant is ‘1’. That is, only when the frequency hopping flag indicates the non-SBFD Msg3 PUSCH frequency hopping, the second to fifth methods may determine whether to perform the SBFD Msg3 PUSCH frequency hopping.

According to an embodiment, the UE may not apply the frequency hopping by being indicated with ‘0’ as the frequency hopping offset value. According to an embodiment, the UE may be configured with the frequency hopping offset value of the SBFD Msg3 PUSCH as shown in Table 20. Referring to Table 20, the UE may be indicated with ‘0’ as the frequency hopping offset value. In this case, the UE may transmit the SBFD Msg3 PUSCH without applying the frequency hopping offset.

TABLE 20

| Number of PRBs | Value of N_{ULhop} | Frequency offset for |
|---|---|---|
| in UL subband | Hopping Bits | 2^{nd} hop in SBFD symbol |
| N_{ULSB} < [50] | 0 | └N_{ULSB}/2┘ |
| | 1 | 0 |
| N_{ULSB} ≥ [50] | 00 | └N_{ULSB}/2┘ |
| | 01 | 0 |
| | 10 | 0 |
| | 11 | Reserved |

Referring to Table 18 and Table 19, the UE may independently determine the number of hopping bits of the SBFD Msg3 PUSCH and the number of hopping bits of the non-SBFD Msg3 PUSCH. For example, when the size of the initial UL BWP is 50RB or more and the size of the SBFD UL subband is less than 50RB, the hopping bits of the non-SBFD Msg3 PUSCH may be determined as 2 bits and the hopping bit of the SBFD Msg3 PUSCH may be determined as 1 bit. In such an example, the UE may encounter the following ambiguity when interpreting the PUSCH frequency resource allocation field. For example, when interpreting the PUSCH frequency resource allocation field, the UE may acquire the frequency-domain allocation information by using the remaining bits excluding bits corresponding to the determined hopping bits from the MSB. The UE may acquire the frequency hopping offset value using the bits acquired from the MSB, corresponding to the number of determined hopping bits. Since the number of determined hopping bits is different, the UE may be ambiguous about how many hopping bits to exclude from the MSB to interpret the remaining bits excluding the hopping bits as the frequency-domain allocation information. Methods for resolving this problem are disclosed.

In a first method, the UE may determine the hopping bits based on one symbol type and use the same number of hopping bits for other symbol types.

For example, the UE may always determine the hopping bits of the non-SBFD Msg3 PUSCH and determine the value as the hopping bits of the SBFD Msg3 PUSCH. If the size of the initial UL BWP is 50RB or more, the UE may consider the hopping bits of the non-SBFD Msg3 PUSCH and the hopping bits of the SBFD Msg3 PUSCH as 2 bits. If the size of the initial UL BWP is less than 50RB, the UE may consider the hopping bits of the non-SBFD Msg3 PUSCH and the hopping bits of the SBFD Msg3 PUSCH as 1 bit. In this case, the hopping bits may be determined regardless of the size of the SBFD UL subband.

For example, the UE may always determine the hopping bits of the SBFD Msg3 PUSCH and determine the value as the hopping bits of the non-SBFD Msg3 PUSCH. If the size of the SBFD UL subband is 50RB or more, the UE may consider the hopping bits of the non-SBFD Msg3 PUSCH and the hopping bits of the SBFD Msg3 PUSCH as 2 bits. If the size of the SBFD UL subband is less than 50RB, the UE may consider the hopping bits of the non-SBFD Msg3 PUSCH and the hopping bits of the SBFD Msg3 PUSCH as 1 bit. In this case, the hopping bits may be determined regardless of the size of the initial UL BWP.

For example, the UE may determine one symbol type based on the scheduling information. For example, the hopping bits may be determined based on the symbol type in which the Msg3 PUSCH scheduled for the UE is first transmitted. Here, the symbol type transmitted first may be the Msg3 PUSCH repetition that is earliest in time.

In a second method, the UE may determine the hopping bits of the SBFD Msg3 PUSCH and the hopping bits of the non-SBFD Msg3 PUSCH, respectively, and determine the hopping bits using one of the two values. For example, the hopping bits may be determined based on the larger value of the two values. For example, the hopping bits may be determined based on the smaller value of the two values.

According to an embodiment, when the hopping bits are determined based on the larger value, the UE may acquire the frequency-domain allocation information using the remaining bits excluding the MSB corresponding to the value.

According to an embodiment, when the hopping bits are determined based on the larger value, the frequency hopping offset value may be acquired based on the same larger value even in a symbol type having the smaller value as the value of hopping bits. For example, when the hopping bits of the non-SBFD Msg3 PUSCH are 2 bits and the hopping bits of the SBFD Msg3 PUSCH are 1 bit, 2 bits may be determined as the final hopping bits. The MSB 2 bits of the PUSCH frequency resource allocation field may be used to determine the frequency hopping offset value. Referring to Table 18 and Table 19, when the MSB 2 bits are ‘00’, the frequency hopping offset value of the non-SBFD Msg3 PUSCH may be └N_{BWP}^{size}/2┘ and the frequency hopping offset value of the SBFD Msg3 PUSCH may be └N_{ULSB}/2┘, when the MSB 2 bits are ‘01’, the frequency hopping offset value of the non-SBFD Msg3 PUSCH may be └N_{BWP}^{size}/4┘ and the frequency hopping offset value of the SBFD Msg3 PUSCH may be └N_{ULSB}/4┘, and when the MSB 2 bits are ‘10’, the frequency hopping offset value of non-SBFD Msg3 PUSCH may be −└N_{BWP}^{size}/2┘ and the frequency hopping offset value of the SBFD Msg3 PUSCH may be −└N_{ULSB}/2┘.

According to an embodiment, when the hopping bits are determined based on the larger value, in the symbol type having the smaller values as the values of the hopping bits, only some of the larger value may be used to determine the frequency hopping offset value. For example, if the larger value is 2 bits and the smaller value is 1 bit, the frequency hopping offset value may be determined using 1 bit (least significant bit (LSB)) out of 2 bits. Referring to Table 18 and Table 19, when the MSB 2 bits are ‘00’, the frequency hopping offset value of the non-SBFD Msg3 PUSCH is └N_{BWP}^{size}/2┘, and when the MSB 2 bits are ‘01’, the frequency hopping offset value of the non-SBFD Msg3 PUSCH is └N_{BWP}^{size}/4┘. When 1 bit (LSB) out of 2 bits is ‘0’, the frequency hopping offset value of the SBFD Msg3 PUSCH may be └N_{ULSB}/2┘, and when 1 bit (LSB) out of 2 bits is ‘1’, the frequency hopping offset value of the SBFD Msg3 PUSCH may be └N_{ULSB}/4┘.

Although the disclosure is described based on the Msg3 PUSCH, the disclosure may also be applied to the PUSCH scheduled in the DCI format. According to an embodiment, for the PUSCH scheduled in the DCI format, the UE may be configured with up to four frequency hopping offsets by the base station. According to an embodiment, when the UE is configured with four offset values in the non-SBFD symbol and two offset values in the SBFD symbol, the UE may determine the frequency hopping offset value through 2-bit MSB bits of the frequency domain resource assignment (FDRA) field of the DCI format. According to an embodiment, in the non-SBFD symbol, one of the four offset values may be indicated using 2 bits, and in the SBFD symbol, one of the two offset values may be indicated using MSB 1 bit of the FDRA field. When the PUSCH scheduled in the DCI format is scheduled across the SBFD symbol and the non-SBFD symbol, the UE may determine the duration of the frequency hopping offset indicator based on the maximum value of the number of bits required in the non-SBFD symbol and the number of bits required in the SBFD symbol. In addition, the duration of the frequency hopping offset indicator in the MSB of the FDRA field may be determined as the frequency hopping offset indicator. According to an embodiment, in the non-SBFD symbol, one of the four offset values may be indicated using 2 bits of the frequency hopping offset indicator, and in the SBFD symbol, one of the two offset values may be indicated using 1 bit (LSB) out of 2 bits of the frequency hopping offset indicator.

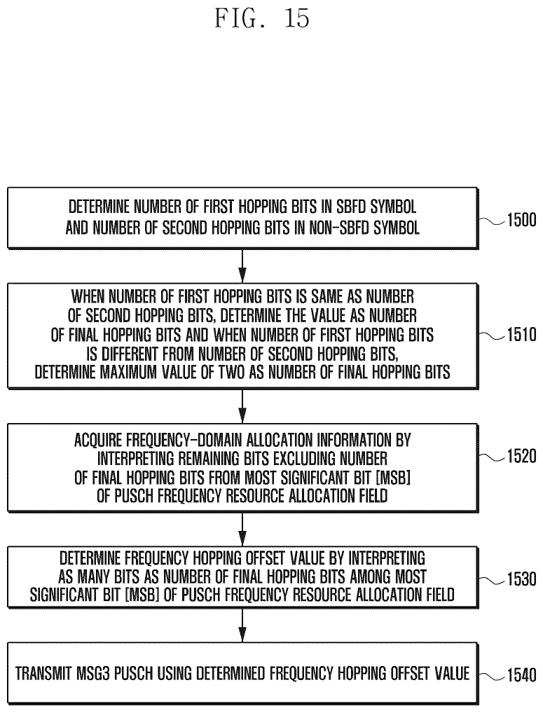

FIG. 15 is a diagram illustrating a flowchart for the Msg3 PUSCH frequency hopping according to an embodiment of the disclosure.

In operation 1500, the UE may determine the number of first hopping bits for the Msg3 PUSCH (SBFD Msg3 PUSCH) to be transmitted in the SBFD symbol and the number of second hopping bits for the Msg3 PUSCH (non-SBFD Msg3 PUSCH) to be transmitted in the non-SBFD symbol. For example, the number of first hopping bits may be determined based on the number of RBs included in the SBFD UL subband, and the number of second hopping bits may be determined based on the number of RBs included in the non-SBFD UL subband.

In operation 1510, the number of first hopping bits and the number of second hopping bits determined by the UE may be the same or different. For example, if the number of first hopping bits and the number of second hopping bits are the same, the value may be determined as the number of final hopping bits. If the number of first hopping bits and the number of second hopping bits are different, the number of final hopping bits may be determined based on the larger value of the two.

In operation 1520, the UE may acquire the PUSCH frequency resource allocation field from the RAR UL grant. For example, the UE may acquire the frequency-domain allocation information by interpreting the remaining bits excluding the MSB bits corresponding to the number of final hopping bits in the field.

In operation 1530, the UE may acquire the PUSCH frequency resource allocation field from the RAR UL grant. The UE may acquire the frequency hopping offset value from the MSB bits corresponding to the number of final hopping bits in the field. For example, a first frequency hopping offset value for the SBFD Msg3 PUSCH may be determined, and a second frequency hopping offset value may be determined for the non-SBFD Msg3 PUSCH. The first frequency hopping offset value and the second frequency hopping offset value may be the same or different.

In operation 1540, the UE may transmit the Msg3 PUSCH using the first frequency hopping offset value in the SBFD symbol, and may transmit the Msg3 PUSCH using the second frequency hopping offset value in the non-SBFD symbol.

The above steps and each configuration may be omitted or applied in combination, according to the embodiment.

### [PUSCH Frequency Hopping Disable]

According to an embodiment of the disclosure, even if the UE is indicated to transmit the PUSCH by applying the frequency hopping, the UE may transmit the PUSCH without applying the frequency hopping. For example, the PUSCH may be repeatedly transmitted in the non-SBFD symbol and the SBFD symbol. In this case, the PUSCH may be transmitted within the UL BWP in the non-SBFD symbol, and the PUSCH may be transmitted within the SBFD UL subband in the SBFD symbol. The bandwidth of the UL BWP may be larger than the bandwidth of the SBFD UL subband. Therefore, frequency diversity may be acquired through frequency hopping-based transmission in the bandwidth of the UL BWP, but a frequency diversity gain that may be acquired through the frequency hopping-based transmission in the SBFD UL subband may be small. Therefore, the frequency hopping-based transmission may not be performed in the SBFD UL subband.

For example, it is possible to determine whether to perform the frequency hopping based on the frequency separation between a first hop and a second hop of the scheduled PUSCH. For example, when the first hop is a low hop in the frequency-domain and the second hop is a high hop in the frequency-domain, the UE may determine the frequency separation between the first hop and the second hop as at least one of the following:
Lowest RB index of the second hop—Lowest RB index of the first hop
Highest RB index of the second hop—Highest RB index of the first hop
Highest RB index of the second hop—Lowest RB index of the first hop

According to an embodiment, the UE may determine whether to perform the frequency hopping based on the frequency separation. When the frequency separation is smaller than a certain size, the UE may not perform the frequency hopping. In this case, the PUSCH may be transmitted at the frequency of the first hop. That is, when the two hops are separated by a certain size or more in the frequency-domain, the two hops may acquire the frequency diversity.

### [PUSCH Transmit Power Control]

According to an embodiment, the UE may apply different transmit power to the PUSCH transmitted in the SBFD symbol and the PUSCH transmitted in the non-SBFD symbol. The UE may dynamically change the transmit power of the PUSCH through signaling from the base station. According to an embodiment, the signaling may include the DCI format that schedules the PUSCH, or the DCI format that does not schedule the PUSCH and only provides power information to one or more UEs.

According to an embodiment, the base station may dynamically control the power of the PUSCH for the UE using 2 bits. The 2 bits may be included in a TPC command for scheduled PUSCH field, and the field may be included in the DCI format for scheduling the PUSCH. The UE may determine the transmit power of the scheduled PUSCH based on the value corresponding to the TPC command for scheduled PUSCH field.

For example, the power of the PUSCH may be changed by −1 dB if the value of the 2-bit TPC command for scheduled PUSCH field is ‘00’, changed by 0 dB if the value of the 2-bit TPC command for scheduled PUSCH field is ‘01’, changed by 1 dB if the value of the 2-bit TPC command for scheduled PUSCH field is ‘10’, and changed by 3 dB if the value of the 2-bit TPC command for scheduled PUSCH field is ‘11’.

A problem to be solved in the disclosure may be a method for dynamically changing transmit power when the PUSCH repetition transmission is scheduled across the SBFD symbol and the non-SBFD symbol.

According to an embodiment of the disclosure, the DCI format for scheduling the PUSCH may include two TPC command for scheduled PUSCH fields. The first TPC command for scheduled PUSCH may correspond to the transmit power of the PUSCH transmitted in the non-SBFD symbol, and the second TPC command for scheduled PUSCH may correspond to the transmit power of the PUSCH transmitted in the SBFD symbol.

According to an embodiment, the first TPC command for scheduled PUSCH field and the second TPC command for scheduled PUSCH field may each be composed of 2 bits. For example, the transmit power of the PUSCH transmitted in the non-SBFD symbol may be changed by −1 dB if a 2-bit value of the first TPC command for scheduled PUSCH field is ‘00’, changed by 0 dB if the 2-bit value of the first TPC command for scheduled PUSCH field is ‘01’, changed by 1 dB if a 2-bit value of the first TPC command for scheduled PUSCH field is ‘10’, and changed by 3 dB if the 2-bit value of the first TPC command for scheduled PUSCH field is ‘11’. For example, the transmit power of the PUSCH transmitted in the SBFD symbol may be changed by −1 dB if a 2-bit value of the second TPC command for scheduled PUSCH field is ‘00’, changed by 0 dB if the 2-bit value of the second TPC command for scheduled PUSCH field is ‘01’, changed by 1 dB if the 2-bit value of the second TPC command for scheduled PUSCH field is ‘10’, and changed by 3 dB if the 2-bit value of the second TPC command for scheduled PUSCH field is ‘11’.

According to an embodiment, the DCI format for scheduling the PUSCH may include one TPC command for scheduled PUSCH field. For example, the TPC command for scheduled PUSCH may correspond to the transmit power of one of the PUSCH transmitted in the non-SBFD symbol and the PUSCH transmitted in the SBFD symbol.

For example, when the PUSCH repetition transmission is scheduled across the SBFD symbol and the non-SBFD symbol, the UE may apply the value of the TPC command for scheduled PUSCH field to only one of the two symbol types. For the PUSCH transmitted in the non-corresponding symbol type, the transmit power may not be dynamically changed.

For example, one symbol type may be a symbol scheduled for a first repetition of the PUSCH repetition transmissions. Alternatively, one symbol type may be a symbol configured by the base station. Alternatively, one symbol type may be indicated in the DCI format. For example, a 1-bit indicator field may be introduced, and if the 1-bit is ‘0’, it may indicate the non-SBFD symbol, and if the 1-bit is ‘1’, it may indicate the SBFD symbol. Alternatively, one symbol type may be determined based on the type of the symbol in which the DCI format is received. When the DCI format is received in the SBFD symbol, one symbol type may be the SBFD symbol. When the DCI format is received in the non-SBFD symbol, one symbol type may be the non-SBFD symbol.

According to an embodiment, the DCI format for scheduling the PUSCH may include one TPC command for scheduled PUSCH field. The TPC command for scheduled PUSCH may be commonly applied to the PUSCH transmitted in the non-SBFD symbol and the PUSCH transmitted in the SBFD symbol.

According to an embodiment, when the DCI format that provides only power information to one or more UEs without scheduling the PUSCH is included, the UE may apply the above-described method. For example, two TPC command for scheduled PUSCH fields may be configured.

According to an embodiment, the UE may be configured with, by the base station, an index of a start bit of the TPC command for scheduled PUSCH (2 bits) for the non-SBFD symbol in the DCI format. The UE may determine 2 bits from the index of the bit as the transmit power of the PUSCH transmitted in the non-SBFD symbol.

According to an embodiment, the UE may be configured with, by the base station, the index of the start bit of the TPC command for scheduled PUSCH (2 bits) for the SBFD symbol in the DCI format. The UE may determine 2 bits from the index of the bit as the transmit power of the PUSCH transmitted in the SBFD symbol.

According to an embodiment, the UE may always assume that the TPC command for scheduled PUSCH (2 bits) for the non-SBFD symbols and the TPC command for scheduled PUSCH (2 bits) for the SBFD symbols are adjacent. The base station may configure the index of the start bit in the DCI format. The UE may determine 2 bits from the index of the bit as the transmit power of the PUSCH transmitted in the non-SBFD symbol. Further, the UE may determine the next 2 bits as the transmit power of the PUSCH transmitted in the SBFD symbol. For example, the UE may acquire 4 bits from the index of the bit, apply the previous 2 bits to the PUSCH transmitted in the non-SBFD symbol, and apply the next 2 bits to the PUSCH transmitted in the SBFD symbol.

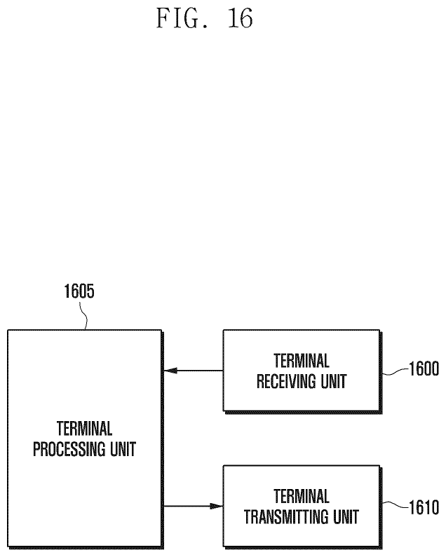

FIG. 16 is a diagram illustrating a structure of the UE in the wireless communication system according to an embodiment of the disclosure.

Referring to FIG. 16, the UE may include a transceiver that refers to a terminal receiving unit 1600 and a terminal transmitting unit 1610, a memory (not illustrated), and a terminal processing unit 1605 (or a terminal control unit or processor). According to the above-described UE communication method, the transceivers 1600 and 1610, the memory, and the terminal processing unit 1605 of the UE may operate. The terminal processing unit 1605 (or processor) may control the operation of the UE according to each of the above-described embodiments as well as at least one combination of the embodiments. However, the components of the UE are not limited to the above-described examples. For example, the UE may include more or fewer components than the above-described components. In addition, the transceiver, the memory, and the processor may be implemented in the form of a single chip.

The transceiver may transmit and receive a signal to and from the base station. Here, the signal may include control information and data. To this end, the transceiver may be composed of an RF transmitter that up-converts and amplifies a frequency of a transmitted signal, and an RF receiver that low-noise amplifies a received signal and down-converts a frequency of the received signal. However, this is only an embodiment of the transceiver, and the components of the transceiver are not limited to the RF transmitter and the RF receiver.

In addition, the transceiver may receive a signal through a wireless channel and output the received signal to the processor, and transmit the signal output from the processor through the wireless channel.

The memory may store a program and data necessary for the operation of the UE. In addition, the memory may store the control information or data included in the signal transmitted and received by the UE. The memory may be configured as a storage medium such as a read only memory (ROM), a random access memory (RAM), a hard disk, a compact disc (CD)-ROM, and a digital versatile disc (DVD), or a combination of storage media. In addition, there may be a plurality of memories.

In addition, the processor may control a series of processes so that the UE may operate according to the above-described embodiment. For example, the processor may receive the DCI composed of two layers and control the components of the UE to receive multiple PDSCHs simultaneously. There may be a plurality of processors, and the processor may perform a component control operation of the UE by executing the program stored in the memory.

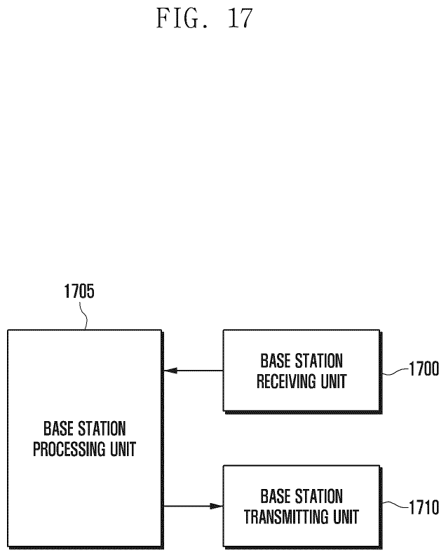

FIG. 17 is a diagram illustrating a structure of the base station in the wireless communication system according to an embodiment of the disclosure.

Referring to FIG. 17, the base station may include a transceiver that refers to a base station receiving unit 1700 and a base station transmitting unit 1710, a memory (not illustrated), and a base station processing unit 1705 (or a base station control unit or a processor). According to the above-described base station communication method, the transceivers 1700 and 1710, the memory, and the base station processing unit 1705 of the base station may operate. The base station processing unit 1705 (or processor) may control the operation of the base station according to each of the above-described embodiments as well as at least one combination of the embodiments. However, the components of the base station are not limited to the above-described examples. For example, the base station may include more or fewer components than the above-described components. In addition, the transceiver, the memory, and the processor may be implemented in the form of a single chip.

The transceiver may transmit and receive a signal to and from the UE. Here, the signal may include control information and data. To this end, the transceiver may be composed of an RF transmitter that up-converts and amplifies a frequency of a transmitted signal, and an RF receiver that low-noise amplifies a received signal and down-converts a frequency of the received signal. However, this is only an embodiment of the transceiver, and the components of the transceiver are not limited to the RF transmitter and the RF receiver.

In addition, the transceiver may receive a signal through a wireless channel and output the received signal to the processor, and transmit the signal output from the processor through the wireless channel.

The memory may store a program and data necessary for the operation of the base station. In addition, the memory may store control information or data included in the signal transmitted and received by the base station. The memory may be configured as a storage medium such as a ROM, a RAM, a hard disk, a CD-ROM, and a DVD, or a combination of storage media. In addition, there may be a plurality of memories.

The processor may control a series of processes so that the base station may operate according to the above-described embodiment of the disclosure. For example, the processor may control each component of the base station to configure and transmit two layers of DCIs including allocation information for multiple PDSCHs. There may be a plurality of processors, and the processor may perform a component control operation of the base station by executing the program stored in the memory.

Methods according to the embodiments described in the claims or specifications of the disclosure may be implemented in the form of hardware, software, or a combination of hardware and software.

When implemented in software, a computer-readable storage medium storing one or more programs (software modules) may be provided. One or more programs stored in the computer-readable storage medium are configured to be executable by one or more processors in an electronic device. One or more programs include instructions for causing an electronic device to execute methods according to embodiments described in a claim or specification of the disclosure.

Such programs (software module, software) may be stored in a random access memory, a non-volatile memory including flash memory, a read only memory (ROM), an electrically erasable programmable read only memory (EEPROM), a magnetic disc storage device, a compact disc-ROM (CD-ROM), digital versatile discs (DVDs), any other form of optical storage device, and a magnetic cassette. Alternatively, the programs may be stored in a memory composed of a combination of some or all thereof. In addition, each configuration memory may be included in plurality.

In addition, the program may be stored in an attachable storage device that may accessed via a communication network such as the Internet, the Intranet, a local area network (LAN), wide LAN (WLAN), or a storage area network (SAN), or a combination thereof. Such a storage device may be connected to a device implementing an embodiment of the disclosure through an external port. In addition, a separate storage device on the communication network may be connected to the device implementing the embodiment of the disclosure.

In the specific embodiments of the disclosure described above, elements included in the disclosure are expressed in the singular or plural according to the specific embodiments presented. However, the singular or plural expression is appropriately selected for the context presented for convenience of description, and the disclosure is not limited to the singular or plural components, and even if the component is expressed in plural, the component is configured in singular or even if the component is expressed in singular, the element may be configured in plural.

In addition, each embodiment may be operated in combination with each other as needed. For example, parts of one embodiment of the disclosure and parts of another embodiment may be combined to operate the base station and the UE. For example, parts of the first and second embodiments of the disclosure may be combined with each other to operate the base station and the UE. In addition, although the above-described embodiments have been presented based on an FDD LTE system, other modifications based on the technical ideas of the above-described embodiments can be realized in other systems such as a TDD LTE system and a 5G or NR system.

Meanwhile, the order of description in the drawings describing the method of the disclosure does not necessarily correspond to the order of execution, and the order of precedence can be changed or executed in parallel.

Alternatively, the drawings describing the method of the disclosure may omit some components and include only some components within a scope that does not harm the essence of the disclosure.

In addition, the method of the disclosure may be executed by combining some or all of the contents included in each embodiment within a scope that does not harm the essence of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
receiving, from a base station, configuration information associated with a subband non-overlapping full duplex (SBFD) symbol;
identifying whether one or more symbols allocated for a physical uplink shared channel (PUSCH) associated with random access (RA) are all SBFD symbols and do not include a symbol of a synchronization signal (SS)/physical broadcast channel (PBCH) block; and
in case that the one or more symbols allocated for the PUSCH are all SBFD symbols and do not include the symbol of the SS/PBCH block, transmitting, to the base station, the PUSCH,
wherein the SBFD symbol is for an uplink transmission using at least one of a downlink symbol or a flexible symbol.

2. The method of claim 1, further comprising:
identifying whether a symbol type for a PUSCH repetition is associated with an SBFD.

3. The method of claim 1,
wherein the configuration information comprises a cell-specific configuration,
wherein the configuration information is received via system information block (SIB), and
wherein the PUSCH comprises a message 3 PUSCH repetition associated with the RA.

4. The method of claim 1, further comprising:
based on an uplink subband size associated with a physical resource block (PRB), identifying a frequency offset for a second hop (2nd hop).

5. A method performed by a base station in a wireless communication system, the method comprising:
transmitting, to a terminal, configuration information associated with a subband non-overlapping full duplex (SBFD) symbol; and
in case that one or more symbols allocated for a physical uplink shared channel (PUSCH) associated with random access (RA) are all SBFD symbols and do not include a symbol of a synchronization signal (SS)/physical broadcast channel (PBCH) block, receiving, from the terminal, the PUSCH,
wherein the SBFD symbol is for an uplink transmission using at least one of a downlink symbol or a flexible symbol.

6. The method of claim 5,
wherein a symbol type for a PUSCH repetition is identified by the terminal, and
wherein a frequency offset for a second hop (2nd hop) is identified by the terminal based on an uplink subband size associated with a physical resource block (PRB).

7. The method of claim 5,
wherein the configuration information comprises a cell-specific configuration,
wherein the configuration information is transmitted via system information block (SIB), and
wherein the PUSCH comprises a message 3 PUSCH repetition associated with the RA.

8. A terminal in a wireless communication system, the terminal comprising:
a transceiver; and
at least one processor coupled with the transceiver and configured to:
receive, from a base station, configuration information associated with a subband non-overlapping full duplex (SBFD) symbol,
identify whether one or more symbols allocated for a physical uplink shared channel (PUSCH) associated with random access (RA) are all SBFD symbols and do not include a symbol of a synchronization signal (SS)/physical broadcast channel (PBCH) block, and
in case that the one or more symbols allocated for the PUSCH are all SBFD symbols and do not include the symbol of the SS/PBCH block, transmit, to the base station, the PUSCH,
wherein the SBFD symbol is for an uplink transmission using at least one of a downlink symbol or a flexible symbol.

9. The terminal of claim 8, wherein the at least one processor is further configured to:
identify whether a symbol type for a PUSCH repetition is associated with an SBFD.

10. The terminal of claim 8,
wherein the configuration information comprises a cell-specific configuration,
wherein the configuration information is received via system information block (SIB), and
wherein the PUSCH comprises a message 3 PUSCH repetition associated with the RA.

11. The terminal of claim 8, wherein the at least one processor is further configured to:
based on an uplink subband size associated with a physical resource block (PRB), identify a frequency offset for a second hop (2nd hop).

12. A base station in a wireless communication system, the base station comprising:
a transceiver; and
at least one processor coupled with the transceiver and configured to:
transmit, to a terminal, configuration information associated with a subband non-overlapping full duplex (SBFD) symbol, and
in case that one or more symbols allocated for a physical uplink shared channel (PUSCH) associated with random access (RA) are all SBFD symbols and do not include a symbol of a synchronization signal (SS)/physical broadcast channel (PBCH) block, receive, from the terminal, the PUSCH,
wherein the SBFD symbol is for an uplink transmission using at least one of a downlink symbol or a flexible symbol.

13. The base station of claim 12,
wherein a symbol type for a PUSCH repetition is identified by the terminal.

14. The base station of claim 12,
wherein the configuration information comprises a cell-specific configuration,
wherein the configuration information is transmitted via system information block (SIB), and
wherein the PUSCH comprises a message 3 repetition PUSCH associated with the RA.

15. The base station of claim 12,
wherein a frequency offset for a second hop (2nd hop) is identified by the terminal based on an uplink subband size associated with a physical resource block (PRB).
